(19) United States
(12) Patent Application Publication
(10) Pub. No.: US 2025/0069309 A1
(43) Pub. Date: Feb. 27, 2025

(54) SIMULATING PHYSICAL PROPERTIES OF REAL-WORLD OBJECTS

(71) Applicant: NVIDIA Corporation, Santa Clara, CA (US)

(72) Inventor: Ruthie D. Lyle, Durham, NC (US)

(21) Appl. No.: 18/454,752

(22) Filed: Aug. 23, 2023

(51) Int. Cl. G06T 13/40; G06T 19/00

(52) U.S. Cl. CPC G06T 13/40; G06T 19/00; G06T 2200/24; G06T 2210/16; G06T 2219/004

(57) ABSTRACT

Apparatuses, systems, and techniques simulating physical properties of real-world objects. Data for a real-world object is collected. The collected data indicates one or more physical characteristics of the real-world object. A three-dimensional (3D) object is created based on some portion of the collected data. The 3D object has a format that is compatible with a 3D graphics platform. Physics simulation data associated with the 3D object moving within the 3D graphics platform is obtained. Image rendering data associated with the 3D object moving within the 3D graphics platform is stored with the computer system. The image rendering data is based at least in part on the obtained physics simulation data.

### TECHNICAL FIELD

At least one embodiment pertains to systems and methods for simulating physical properties of real-world objects worn. For example, a user can request to access (e.g., using a client device) a simulated representation of a real-world object. A simulated representation of the real-world object can be generated based on data associated with the object, including image data, characteristic data, and physics simulation data, as well as user data associated with the user. The simulated representation can be provided for presentation on a graphical user interface (GUI) on a client device of the user.

### BACKGROUND

Designers and developers of virtual environments (e.g., video game environments) utilize three-dimensional (3D) animation techniques to create immersive and visually captivating experiences for users accessing the virtual environments. Objects in these virtual environments can be significantly complex and detailed, in some instances. For example, a video game environment can include multiple different characters and/or other objects (e.g., scenery objects, game play objects, etc.) that each have its own characteristics and details, such as clothing items, accessories, gear, etc. It can be time consuming for a designer or developer to create and animate the behavior of each clothing item, accessory, gear, etc. for each character and/other object in the environment.

Virtual try-on (also referred to as “virtual fitting” or “digital try-on” technology) technology enables customers to explore or “try on” clothing items using a virtual avatar prior to purchasing the clothing items. The virtual try-on process involves generating a rendering of a clothing item that is worn by a virtual avatar associated with a user and providing the generated rendering to a client device associated with the user for presentation using a graphical user interface on the client device. Simulating clothing on a virtual avatar is a complex and challenging task that involves advanced computer graphics, computer vision, and, in some instances, machine learning techniques. It can be difficult for systems to provide a realistic and accurate representation of the physical characteristics of a clothing item on a virtual avatar.

### BRIEF DESCRIPTION OF DRAWINGS

Various embodiments in accordance with the present disclosure will be described with reference to the drawings, in which:

FIG. 1 is a block diagram of an example system architecture, according to at least one embodiment;

FIG. 2 is a block diagram of an example platform, object management engine, simulation engine, and model engine, according to at least one embodiment;

FIG. 3 illustrates a flow diagram for an example method for providing a rendering of a simulated representation of a real-world object worn by a user, according to at least one embodiment;

FIG. 4 is a block diagram of an example user management engine, according to at least one embodiment;

FIG. 5 illustrates a flow diagram for an example method of updating a virtual avatar associated with a user, according to at least one embodiment;

FIG. 6 is a block diagram of a system including an AI server, according to at least one embodiment;

FIG. 7 illustrates a flow diagram for an example method of providing a rendering of a real-world object, according to at least one embodiment;

FIG. 8A illustrates inference and/or training logic, according to at least one embodiment;

FIG. 8B illustrates inference and/or training logic, according to at least one embodiment;

FIG. 9 illustrates an example data center system, according to at least one embodiment;

FIG. 10 illustrates a computer system, according to at least one embodiment;

FIG. 11 illustrates a computer system, according to at least one embodiment;

FIG. 12 illustrates at least portions of a graphics processor, according to one or more embodiments;

FIG. 13 illustrates at least portions of a graphics processor, according to one or more embodiments;

FIG. 14 is an example data flow diagram for an advanced computing pipeline, in accordance with at least one embodiment;

FIG. 15 is a system diagram for an example system for training, adapting, instantiating and deploying machine learning models in an advanced computing pipeline, in accordance with at least one embodiment; and

FIGS. 16A and 16B illustrate a data flow diagram for a process to train a machine learning model, as well as client-server architecture to enhance annotation tools with pre-trained annotation models, in accordance with at least one embodiment.

### DETAILED DESCRIPTION

Embodiments of the present disclosure relate to methods and systems for simulating physical properties of real-world objects. An online platform can provide, to users of the platform, information regarding with objects (e.g., real-world objects) associated with the platform. For example, a clothing retailer can sell clothing items to users using an e-commerce platform or an apparel services platform. The clothing retailer can provide, using the platform, information associated with real-world clothing items (e.g., a type, a size, a fabric, a color, etc.) that are available for purchase using the platform. A user of the platform can access the information provided by the clothing retailer (e.g., using a client device connected to the platform using a network, etc.) and can consider the provided information when determining whether to purchase a clothing item.

Information provided for an object using an online platform may not be sufficient to convey to a user certain characteristics associated with the object, which may otherwise be conveyed if the user interacts with the object in person. For example, even though size and/or fabric information associated with a real-world clothing item can be provided to a user using an e-commerce platform, the user may not get a sense of a fit of the clothing item (e.g., in view of the user's body type, etc.) and/or a behavior of the fabric of the clothing item based on this information. The user, however, may get a sense of the fit of the clothing item and/or the behavior of the fabric if the user interacts with the clothing item in person (e.g., if the user tries on the clothing item at home or at a brick-and-mortar store, etc.). In another example, a real-world clothing item can be a second-hand clothing item (e.g., a previously used and/or pre-owned clothing item) that includes one or more defects (e.g., through normal wear and tear, etc.). Although information provided using the e-commerce platform can indicate a defect associated with a real-world clothing item to a user, the user may not get a sense of where the defect exists on the clothing item and/or how the defect will look when the user is wearing the clothing item based on the provided information.

Some online platforms may provide a virtual fitting service that allows customers to virtually “try on” clothing items before making a purchase. The platform can generate or otherwise obtain a rendering of a virtual avatar associated with a user of the platform, where the virtual avatar is “wearing” or “trying on” a clothing item offered for sale using the platform. In conventional systems, a rendering of a clothing item is generated based on data provided by a manufacturer or designer of the clothing item. For example, a manufacturer or designer of the clothing item can provide, to the online platform, an indication of sizing information for the clothing item, a sewing pattern for the clothing item, a type of fabric that makes up the clothing item, a color or pattern of the clothing item, and so forth. Such data provided by the manufacturer or the designer represents target characteristics of the clothing item, which may not accurately reflect the actual characteristics of the clothing item after fabrication.

In some instances, a manufacturer or designer of a clothing item can provide image data depicting the clothing item to be used for generating the rendering of the clothing item. However, such image data is captured while the clothing item is worn by a mannequin or is laid flat on a surface, neither of which accurately reflect how the clothing item will look when worn by most, if not all, users of the platform. Further, such image data is enhanced (e.g., using photo or image enhancement software) to improve a lighting of the clothing item, a shape or structure of the clothing item, etc., as depicted by the image data, and/or to remove defects in the clothing item and/or staging items (e.g., tape, etc.) applied to the clothing item while the image data is generated. Accordingly, such image data that may be used to generate a rendering of a clothing item does not accurately reflect the actual characteristics (e.g., color, texture, fit, etc.) of the clothing item when worn by a user.

As indicated above, a rendering of a clothing item is generated based on target characteristic data and/or enhanced image data captured for the clothing item, in conventional systems. However, such data does not provide an indication of the actual, physical characteristics of the clothing item, such as a drape of the clothing item, a shape of the clothing item, a grain of the clothing item, a level of friction of the clothing item, a breathability of the clothing item, an elasticity of the clothing item, and so forth, when the clothing item is worn by a user of the platform. In addition, the enhanced image data used to generate the rendering does not provide an indication of how the clothing item will look to the user when the clothing item is in an environment with conditions that differ from the enhanced conditions of the environment including the clothing item when the image data was generated. Further, as indicated above, image data for the clothing item can be captured when the clothing item is worn by a mannequin, which is placed in a fixed position. Accordingly, the image data used to generate the rendering does not provide an indication of how the clothing item will look to the user when the virtual avatar is in a different position or is moving (e.g., walking, running, etc.) while wearing the clothing item.

For at least the reasons stated above, renderings of clothing items on virtual avatars generated by conventional systems do not give a user an idea or a sense of a fit of the real-world clothing object on the user, how one or more portions of the real-world clothing object will fall on the user, what the real-world clothing object will look like when the user is in different positions, states, and/or environments, and so forth. Data sets used to generate the renderings of clothing items can be significantly large and accordingly can take up a large amount of memory space of a computing system, which is therefore made unavailable to other data. Generating a rendering of a clothing item can further consume a significant amount of computing resources (e.g., processing cycles, etc.), which can make the computing resources unavailable to other processes. As described above, a rendering of a clothing item generated according to conventional techniques does not accurately represent the clothing item when worn by a user of the platform. Accordingly, the memory space and computing resources consumed for generating the rendering of the clothing item may be wasted in conventional systems. Further, a user that purchases a clothing item using an online platform that provides a rendering of a clothing item according to conventional techniques may end up returning the clothing item (e.g., as the rendering of the clothing item does not accurately reflect the physical characteristics of the real-world clothing item). Processes associated with purchasing and returning a clothing item can consume a large amount of computing resources (e.g., of a system associated with the online platform and/or a merchant of the clothing item and of a client device associated with the user). Such resources are unavailable for other processes, which can decrease the efficiency and increase the latency of the overall system.

In other or similar instances, a platform can provide users with access to tools to create and/or modify objects (e.g., three-dimensional (3D) objects) in a virtual environment. For example, a platform (e.g., a 3D graphics collaboration platform) can provide users (e.g., designers developers, etc.) with access to tools and/or resources for designing and/or developing 3D objects for inclusion in a virtual environment. Some objects can be complex and/or involve a high level of detail. For example, a character or object for inclusion in a video game environment can have several clothing items, accessories, gear, etc. that are unique to the character or object (e.g., distinct from clothing items, accessories, gear, etc. of other characters or objects). In some instances, each character and/or object in the virtual environment can have its own unique clothing items, accessories, gear, etc. that each have a high level of complexity or detail. Accordingly, it can take a designer or developer a significant amount of time (e.g., weeks, months, years, etc.) to create and animate each character or object, and the clothing items, accessories, gear, etc. associated with each character or object in a virtual environment. In some instances, 3D graphics design and development tools can consume a significant amount of computing resources (e.g., memory resources, processing resources, etc.) of a system. The larger the amount of time to create and animate a character or object (and the associated clothing items, accessories, gear, etc.), the larger amount of computing resources are consumed in the system. Such computing resources are unavailable to other processes of the system, which can increase an overall latency and decrease an overall efficiency of the system.

Further, platforms may generate or otherwise maintain model files for 3D objects designed, developed, or otherwise provided to the platform (e.g., by a designer or a developer). A model file refers to a collection of data and/or instructions that, when executed by a rendering engine, generates a rendering of a 3D object according to one or more animations. Some conventional 3D graphics design and development tools generate or otherwise update model files to be executed by rendering engines of advanced or otherwise complex processing units (e.g., graphics processing units (GPUs), etc.). In some instances, platforms can provide some users with access to 3D objects designed or otherwise developed by other users of the platform. Model files generated by the above described conventional 3D graphics design and development tools may not be executable using devices associated with such users (e.g., if the devices do not include or have access to advanced or otherwise complex processing units). Accordingly, such 3D objects may be inaccessible to such users.

Embodiments of the present disclosure address the above and other deficiencies by providing techniques for providing a simulated representation of a real-world object to users of a platform a. A platform (e.g., a 3D graphics collaboration platform, a software-as-a-service (SaaS) platform, etc.) can identify image data and/or characteristic data associated with a real-world object. In some embodiments, the real-world object can include a real-world clothing object, such as clothing items, jewelry items, and the like. It should be noted, however, that the real-world object can include any type of object, in accordance with embodiments of the present disclosure. The image data can include one or more images and/or a video depicting the real-world object. In some embodiments, the image data can include three-dimensional (3D) image data that is generated using a 3D scanning device. The characteristic data can indicate one or more physical characteristics of the real-world object. For example, the characteristic data can include a size of the clothing object, one or more colors of the clothing object, one or more measurements associated with the clothing object (e.g., sleeve length, etc.), one or more fabrics of the clothing object, and so forth. In some instances, the real-world clothing item can include one or more defects (e.g., a small hole in or under a sleeve, etc.). The characteristic data can include information associated with the one or more defects (e.g., a type of the defect, a location of the defect, a size of the defect, etc.), in some embodiments. The platform can receive the image data and/or the characteristic data from a client device associated with a retailer of the real-world clothing object, in some embodiments.

The platform can obtain physics simulation data associated with the real-world object based on at least the characteristic data associated with the real-world object. Physics simulation data can indicate or otherwise correspond to one or more physical states associated with the real-world object in view of a simulated physical behavior of the real-world clothing object. In some embodiments, the platform can obtain the physics simulation data from a physics simulation engine. The physics simulation engine can be configured to generate the physics simulation data based on the simulated physical behavior of the clothing object in view of soft-body dynamics associated with the clothing object. In an illustrative example, the real-world clothing object can be a silk dress. The physics simulation engine can generate, in view of at least the characteristic data associated with the silk dress, physics simulation data associated with a simulated behavior of the silk dress, such as a movement of the silk dress, a state of one or more portions of the silk dress when it is draped on another object, etc.

The platform can update one or more model files associated with generating a rendering of the real-world object to include information pertaining to one or more animations for the rendering of the real-world object based on the obtained physics data. In an illustrative example, the physics simulation data generated by the physics simulation engine can indicate a movement of a silk dress, a state of one or more portions of the silk dress when it is draped on another object, etc. The platform can update the one or more model files to include data and/or instructions for rendering an animation of a 3D representation of the silk dress according to the movement and/or draping simulated by the physics simulation engine.

In some embodiments, the platform can update rendering data associated with generating the rendering of the animation of the real-world object. In some embodiments, the rendering data can include data of one or more model files associated with generating the rendering of the animation of the real-world object. Each model file can correspond to a distinct rendering format for rendering the real-world object. A rendering format of a model file represents or otherwise defines data organization and compression techniques that are to be applied by a rendering engine to data and/or instructions of a model file to generate the rendering of the animation of a 3D object. In some instances, client devices and/or applications (or application instances) executing using the client devices can be configured to execute model files having particular rendering formats (e.g., according to a type of hardware components of the client devices, etc.). Each model file associated with generating the rendering of the animation of the real-world object that is updated by the platform can have a distinct rendering format. Accordingly, the model files updated by the platform can be executed by rendering engines associated with client devices and/or applications that support different types of model file rendering formats.

A client device of the user of the platform (or another platform) can transmit a request to access a simulated representation of the real-world object. Accordingly, the user is referred to herein as being interested in the real-world item (i.e., an “interested user”). In some embodiments, the platform can determine a rendering format associated with the client device and can identify a subset of the rendering data (e.g., a particular model file) associated with a rendering format that corresponds to the determined rendering format. In some embodiments, the platform can provide the identified subset of the rendering data to the client device for execution to generate the rendering of the real-world object according to the animations based on the obtained physics simulation data. In some embodiments, the client device can execute the model file (e.g., of the updated rendering data) to generate the rendering of the animation of the real-world object and can present the generated rendering to the user via a graphical user interface (GUI) of the client device, in some embodiments.

In some embodiments, the platform (or another platform) can generate the rendering of an avatar associated with the interested user. The avatar can be a realistic, life-like representation of the interested user, in some embodiments. In other or similar embodiments, features of the virtual avatar can be customized by the interested user (e.g., using virtual avatar customization tools of the virtual environment). The interested user can provide, using a client device associated with the interested user, image data and/or video data of the user and the platform can generate the rendering of the avatar based on the image data and/or video data. In additional or alternative embodiments, the platform can generate the rendering of the avatar based on biometric data (e.g., a height, a waist size, etc.) provided by the interested user (e.g., using the client device). The platform can generate the rendering prior to and/or responsive to receiving the request from the client device of the interested user.

The platform and/or the client device can generate a simulated representation of the real-world clothing object worn by the user based on the image data, the characteristic data, the obtained physics data, and user data (e.g., the biometric data, etc.) of the user. The platform can provide a rendering of the simulated representation of the real-world clothing object worn by the user represented by the avatar of the user for presentation of a graphical user interface on the client device of the user. The rendering of the simulated representation of the real-world clothing object with the rendering of the avatar can indicate to the user how the clothing object would fit the user, how one or more portions of the clothing object would fall on the user, and so forth, when the user wears the clothing object in the real world. In accordance with the previous illustrative example, the simulated representation of the silk dress indicates to the user how the silk dress would fall on the avatar based on the image data, the characteristic data, and/or the obtained physics simulation data. In another illustrative example, the real-world clothing object can include a defect, as described above. The rendering of the simulated representation of the real-world clothing object, including the defect, with the rendering of the avatar can indicate to the user how the defect will look on the user wearing the clothing object in the real world.

In some embodiments, the user can request, using the client device, to view the avatar in one or more particular positions or states (e.g., sitting, standing, walking, running, etc.) with the simulated representation of the real-world clothing object. The platform can update the rendering of the avatar based on the requested position or state. In some embodiments, the platform can update the simulated representation of the clothing object in view of the physics data obtained for the clothing object and the requested position or state of the avatar. The platform can provide the updated renderings of the avatar and the simulated representation of the clothing object for presentation using the GUI, in accordance with the request. In additional or alternative embodiments, the platform can update a rendering of an environment (e.g., lighting, weather, etc.) associated with the avatar and/or the simulated representation of the clothing object (e.g., in response to a request from the user). The updated rendering can indicate to the user how the real-world clothing object will appear and/or behave on the avatar in the respective environment.

Aspects and embodiments of the present disclosure provide techniques to provide users of a platform with access to a rendering of a real-world clothing object that accurately reflects the actual characteristics of the object, rather than target characteristics of the object. By using image data, characteristic data, and physics data to generate a simulated representation of a real-world clothing object worn by a user, embodiments of the present disclosure can provide to users an accurate representation of how a real-world clothing item will look and/or fit on the user, and the user can make a more informed decision on whether to purchase the real-world clothing item. As techniques of the present disclosure provides users with an accurate rendering of the real-world clothing items prior to purchasing, computing resources (e.g., processing cycles, etc.) consumed for generating the rendering of the clothing item is not wasted. Further, users that access (e.g., purchase) clothing items using an online platform that generates renderings according to techniques of the present disclosure are less likely to return clothing items, and therefore a fewer amount of computing resources of the system are consumed. Such resources are available for other processes of the system, which can increase an efficiency and decrease a latency of the overall system.

Aspects and embodiments of the present disclosure further provide techniques to enable users (e.g., designers, developers, etc.) of a platform to design or develop 3D objects in a virtual environment. Embodiments of the present disclosure enable designers and developers to create and/or customize 3D objects in a virtual environment based on image data captured for a real-world object (e.g., a real-world clothing object) and physics simulation data for the object obtained based on outputs of a physics simulation engine. Designers and developers therefore can create and/or customize the 3D objects in a smaller amount of time (e.g., hours, days, etc.), which can lead to a reduction in a number of computing resources (e.g., memory resources, processing cycles, etc.) consumed during the 3D object design and/or development process. Further, embodiments of the present disclosure enable platforms or systems to generate or otherwise maintain model files for 3D objects having different rendering formats that are supported by different types of client devices and/or applications (or application instances) executing using the client devices. Accordingly, a larger number of users can access 3D objects designed or developed using 3D graphics design and development tools. For example, model files can be generated or otherwise maintained having a rendering format associated with client devices that do not include advanced or otherwise complex processing units. The systems and methods described herein may be used for a variety of purposes, by way of example and without limitation, these purposes may include systems or applications for online multiplayer gaming, machine control, machine locomotion, machine driving, synthetic data generation, model training, perception, augmented reality, virtual reality, mixed reality, robotics, security and surveillance, autonomous or semi-autonomous machine applications, deep learning, environment simulation, data center processing, conversational AI, light transport simulation (e.g., ray tracing, path tracing, etc.), collaborative content creation for 3D assets, digital twin systems, cloud computing and/or any other suitable applications.

Disclosed embodiments may be comprised in a variety of different systems such as systems for participating on online gaming, automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems implemented using an edge device, systems incorporating one or more virtual machines (VMs), systems for performing synthetic data generation operations, systems implemented at least partially in a data center, systems for performing conversational AI operations, systems for performing light transport simulation, systems for performing collaborative content creation for 3D assets, systems for generating or maintaining digital twin representations of physical objects, systems implemented at least partially using cloud computing resources, and/or other types of systems.

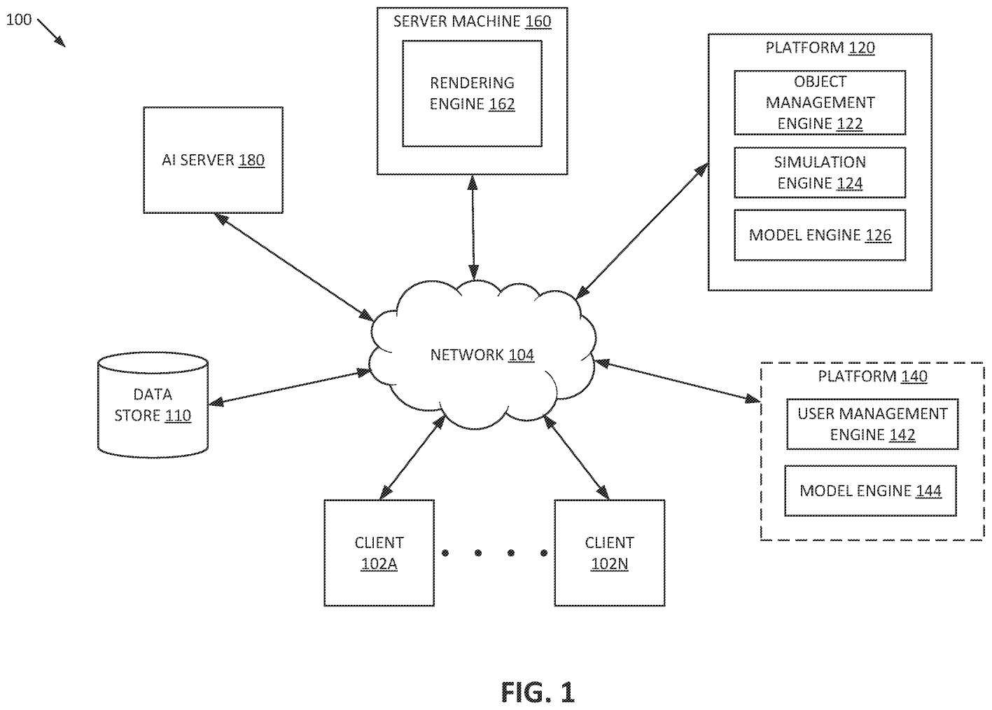

FIG. 1 is a block diagram of an example system architecture 100, according to at least one embodiment. The system architecture 100 (also referred to as “system” herein) includes client devices 102A-N, a data store 110, a platform 120 (e.g., an e-commerce platform, a clothing services platform, etc.), a server machine 160, and/or an artificial intelligence (AI) server 180, each connected to a network 104. In additional or alternative embodiments, system 100 can optionally include a platform 140 (e.g., a three-dimensional (3D) graphics collaboration platform) that is connected to client devices 102A-N, data store 110, platform 120, server machine 160, and/or AI server 180 using network 104. In implementations, network 104 may include a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), routers, hubs, switches, server computers, and/or a combination thereof.

The client devices 102A-N (collectively and individually referred to as client device(s) 102 herein) may each include computing devices such as personal computers (PCs), laptops, mobile phones, smart phones, tablet computers, netbook computers, network-connected televisions, etc. In other or similar embodiments, client devices 102A-N can include or be connected to a virtual reality (VR) device (e.g., a VR headset) that is configured to provide a VR experience to a user of platform 120 and/or platform 140. The VR device can be a monolithic VR device (e.g., a VR headset that includes a dedicated processor and/or power source) or another type of VR device, in some embodiments. In some implementations, client devices 102A-N may also be referred to as “user devices.” Each client device may include a content viewer. In some implementations, a content viewer may be an application that provides a user interface (UI) for users to view or upload content, such as images, video items, web pages, documents, etc. For example, the content viewer may be a web browser that can access, retrieve, present, and/or navigate content (e.g., web pages such as Hyper Text Markup Language (HTML) pages, digital media items, etc.) served by a web server. The content viewer may render, display, and/or present the content to a user. The content viewer may also include an embedded media player (e.g., a Flash® player or an HTML5 player) that is embedded in a web page (e.g., a web page that may provide information about a product sold by an online merchant). In another example, the content viewer may be a standalone application (e.g., a mobile application or app) that allows users to view digital media items (e.g., digital video items, digital images, electronic books, etc.).

Platform 120 can provide users with access to renderings of one or more real-world objects. The real-world objects can be real-world clothing objects (sometimes referred to as clothing objects herein), in some embodiments. As noted herein, the real-world objects can include any type of real-world object, in some embodiments. “Clothing objects” is used herein for purposes of example and illustration only.

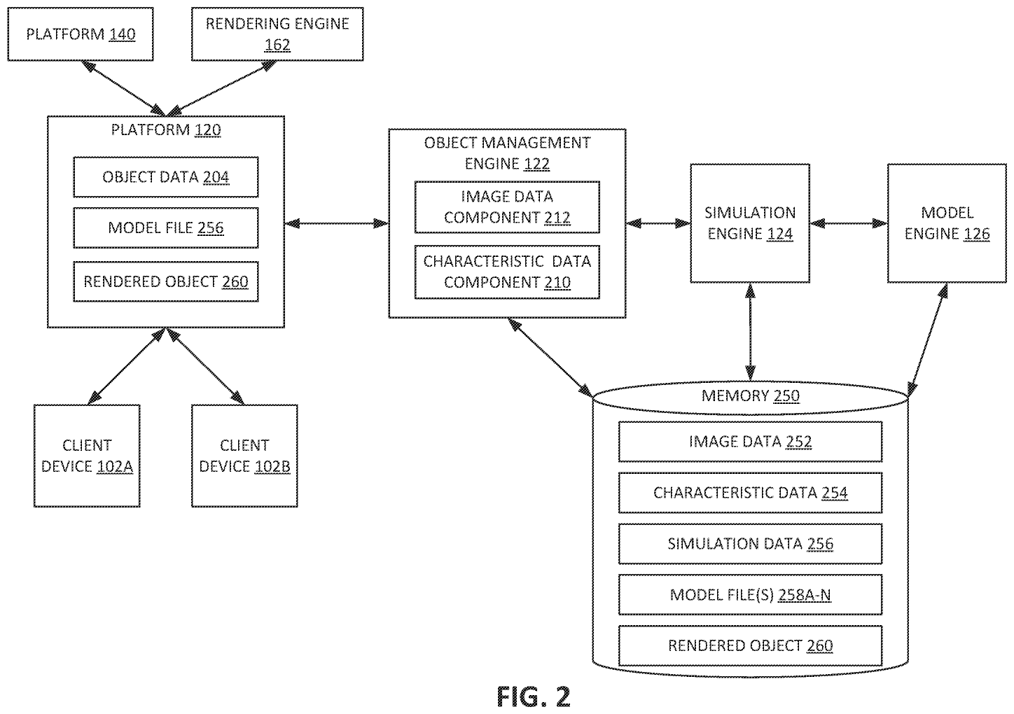

In some embodiments, platform 120 can be or correspond to a clothing services platform or other similar type platform. In other or similar embodiments, platform 120 can correspond to a 3D object design and development platform. As illustrated in FIG. 1, platform 120 can include an object management engine 122, a simulation engine 124, and/or a model engine 126, in some embodiments. In additional or alternative embodiments, object management engine 122, simulation engine 124, and/or model engine 126 can reside at one or more server machines (e.g., server machine 160, another server machine not shown, etc.). In such embodiments, platform 120 can access object management engine 122, simulation engine 124, and/or model engine 126 using network 104. Object management engine 122 can be configured to manage image data and/or characteristic data associated with a clothing object (e.g., provided by a user of a client device 102). Simulation engine 124 can be configured to simulate one or more characteristics of the clothing object based on the image data and/or characteristic data for the clothing object. The simulation of the one or more characteristics of the clothing object can be represented by simulation data generated by simulation engine 124. In some embodiments, simulation engine 124 can be a physics simulation engine. Model engine 126 can be configured to generate a model file that, when rendered, depicts a real-world clothing object. In some embodiments, model engine 126 can generate the model file based on image data, characteristic data, and/or simulation data associated with the real-world clothing object, as described herein. In other or similar embodiments, model engine 126 may obtain a model file (e.g., from object management engine 122, from another engine or component of system 100, etc.) and can update or otherwise modify the model file prior to rendering of the clothing object. Platform 120 (and/or platform 140) can provide a rendering of the clothing object to a user associated with a client device 102, in accordance with embodiments of the present disclosure. Further details regarding platform 120, object management engine 122 and simulation engine 124 are provided with respect to FIG. 2A.

Platform 140 can provide users with access to renderings of one or more virtual avatars (sometimes referred to as avatars herein), in some embodiments. In some embodiments, platform 140 can be or can otherwise correspond to a 3D graphics collaboration platform, such the Omniverse™ Platform by NVIDIA Corporation. A virtual avatar refers to a virtual character or representation associated with a user. The user can control the virtual avatar (e.g., using an associated client device 102) and/or can interact with virtual avatars associated with other users using the application. In some embodiments, the virtual avatar associated with the user can be generated based on image data (e.g., photos, video data, etc.) provided to platform 120 (e.g., by the user) and can depict one or more characteristics of the user. In other or similar embodiments, the virtual avatar can depict one or more characteristics of a character selected by the user. It should be noted that embodiments of the present disclosure apply to any type of virtual avatar and/or any type of 3D object.

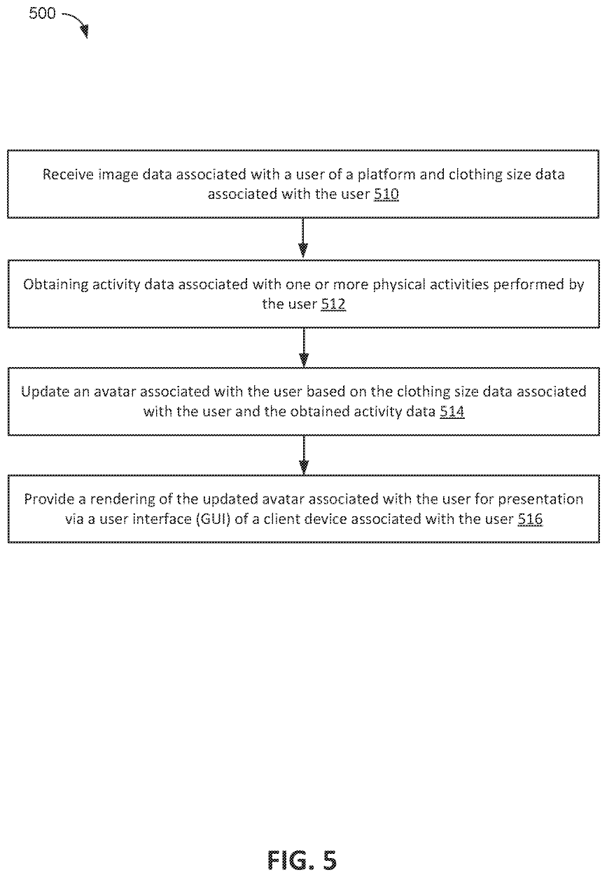

Platform 140 can include a user management engine 142 and/or a model engine 144, in some embodiments. In additional or alternative embodiments, user management engine 132 and/or model engine 144 can reside at one or more server machines (e.g., server machine 160, another server machine not shown, etc.). In such embodiments, platform 140 can access user management engine 142 and/or model engine 144 using network 104. User management engine 142 can be configured to manage data associated with one or more users of platform 140. In some embodiments, user management engine 142 can obtain data associated with a virtual avatar associated with the user (e.g., from client device 102) and can store the obtained data at data store 110. The obtained data can include image data associated with the user, one or more avatar characteristics associated with the virtual avatar (e.g., clothing style, hair style, hair color, accessories), and so forth. In some embodiments, the data associated with the virtual avatar can be obtained and/or updated in accordance with embodiments of FIG. 5. Model engine 144 can be configured to generate a model file that, when rendered, depicts a virtual avatar associated with a user. Model engine 144 can generate the model file based on the obtained user data, in some embodiments. In other or similar embodiments, model engine 144 may obtain a model file (e.g., from user management engine 142, from another engine or component of system 100, etc.) and can update or otherwise modify the model file prior to rendering of the virtual avatar.

Rendering engine 162 can render display data and/or image data from object data for transmission to and/or presentation by client device(s) 102A-N. In some embodiments, rendering engine 162 can correspond to RTX Renderer™ from NVIDIA Corporation. Rendering engine 162 can leverage any number of processing units (e.g., graphical processing units (GPUs)) and/or nodes thereof for rendering the display data and/or image data from the object data. In some embodiments, rendering engine 162 can execute ray tracing (e.g., real time ray tracing) and/or path tracing using one or more GPUs to generate photo-realistic renderings of objects associated with object data. Object data can include data used by rendering engine 162 to render a 3D object (e.g., a real-world clothing object, a virtual avatar, etc.).

In some embodiments, the object data can indicate a bone structure associated with the 3D object, an indication of a mesh (e.g., a polygon mesh) for the 3D object, and/or an indication of one or more blend shapes (also referred to as morph targets) for the 3D object. The bone structure can include one or more bones that are each indicated by a bone index. The mesh can include one or more polygons made up of vertices, edges, and faces. Each blend shape can represent a distinct representation of at least a portion of the 3D object. For example, object data can include blend shapes for one or more faces of a virtual avatar, including a frowning face, a smiling face, and so forth. The object data can, in some embodiments, include an indication of a motion vector for each vertex of at least a portion of the mesh. A motion vector can indicate a degree and/or a direction of a motion of a respective vertex in accordance with an animation of the 3D object. In an illustrative example, a motion vector can include at least three values each indicating a degree of movement of the vertex according to a respective axis of motion (e.g., an x-axis, a y-axis, a z-axis, etc.). A positive value can indicate movement in a positive direction along the axis, while a negative value can indicate movement in a negative direction along the axis. In some embodiments, the object data can be included in a model file, such as a model file generated or otherwise obtained by model engine 126 and/or model engine 144, as described above.

In some embodiments, rendering engine 162 can be associated with platform 120. In such embodiments, platform 120 can generate first object data associated with a real world-clothing object based on the image data and/or the characteristic data associated with the real-world clothing object, as described above. In additional or alternative embodiments, the first object data can be generated based on simulation data obtained from simulation engine 124, as described herein. Platform 120 can also obtain (e.g., from data store 110, from platform 140, etc.) second object data associated with a virtual avatar of a user of platform 120 and/or platform 140. Platform 120 can provide the first object data and the second object data to rendering engine 162 and rendering engine 162 can generate a rendering of a real-world clothing object worn by a virtual avatar associated with a user based on the first object data and the second object data. Platform 120 and/or platform 140 can provide the rendering to a client device 102 for presentation to a user, in accordance with embodiments described herein. In other or similar embodiments, rendering engine 162 can reside at a client device 102. In such embodiments, platform 120 and/or platform 140 can provide the first object data and the second object data to client device 102 (e.g., using network 104). Rendering engine 162 at the client device 102 can generate the rendering of a real-world clothing object worn by a virtual avatar associated with a user based on the first object data and the second object data. The client device 102 can provide the rendering to a user using a UI of client device 102, as described herein. Further details regarding platform 120, platform 140, and rendering engine 162 are provided herein.

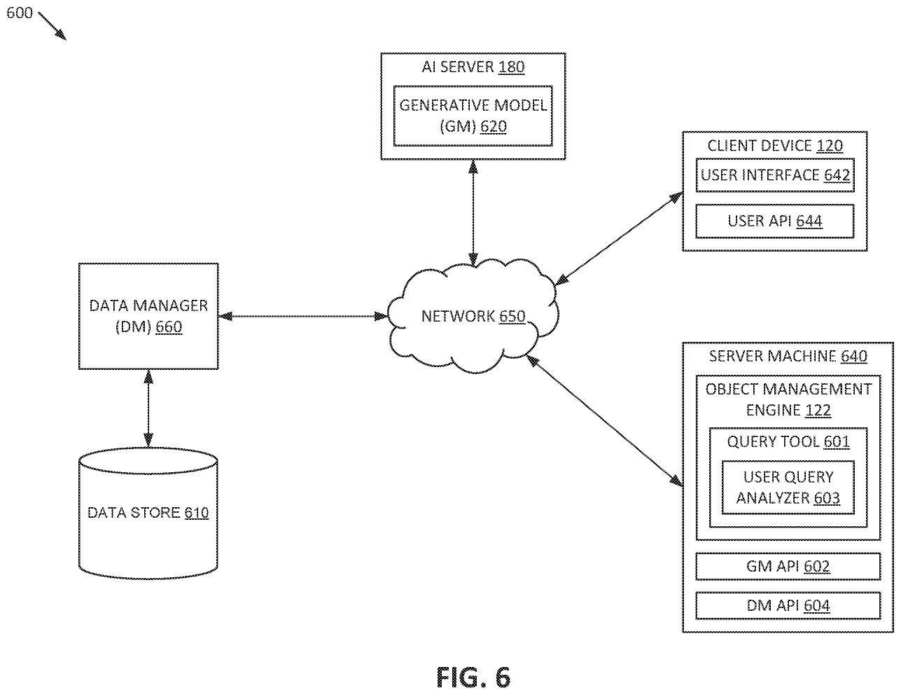

As illustrated in FIG. 1, system 100 can include an AI server 180. In some embodiments, AI server 522 can include a generative model that can generate data in response to or otherwise associated with a request from a user of client device 102. Further details regarding AI server 180 are provided with respect to FIG. 6.

It should be noted that although some embodiments of this disclosure provide that platform 120 is a distinct platform from platform 140, in additional or alternative embodiments, platform 120 and platform 140 can be or can otherwise correspond to the same platform. For example, components of platform 120 (e.g., object management engine 122, simulation engine 124, model engine 126, etc.) can reside at or can be otherwise accessible to platform 140. In another example, components of platform 140 (e.g., user management engine 142, model engine 144, etc.) can reside at or can be otherwise accessible to platform 120. In other or similar embodiments, one or more components of platform 120 and/or platform 140 can reside at or can otherwise be accessible to other platforms not shown in FIG. 1, in accordance with embodiments of the present disclosure.

It should be noted that although FIG. 1 illustrates object management engine 122 and simulation engine 124 as part of platform 120, in additional or alternative embodiments, object management engine 122, simulation engine 124, and/or model engine 126 can reside on one or more server machines that are remote from platform 120. It should also be noted that although FIG. 1 illustrates user management engine 142 and model engine 144 as part of platform 140, in additional or alternative embodiments, user management engine 142 and/or model engine 144 can reside on one or more server machines that are remote from platform 140. It should be noted that in some other implementations, the functions of platform 120, platform 14, server machine 160 and/or AI server 180 can be provided by more or a fewer number of machines. For example, in some implementations, components and/or modules of platform 120, platform 14, server machine 160 and/or AI server 180 may be integrated into a single machine, while in other implementations components and/or modules of any of platform 120, platform 14, server machine 160 and/or AI server 180 may be integrated into multiple machines. In addition, in some implementations, components and/or modules of server machine 160 and/or AI server 180 may be integrated into platform 120 and/or platform 140.

In general, functions described in implementations as being performed platform 120, platform 14, server machine 160 and/or AI server 180 can also be performed on the client devices 102A-N in other implementations. In addition, the functionality attributed to a particular component can be performed by different or multiple components operating together. Platform 120 and/or platform 140 can also be accessed as a service provided to other systems or devices through appropriate application programming interfaces, and thus is not limited to use in websites.

In implementations of the disclosure, a “user” can be represented as a single individual. However, other implementations of the disclosure encompass a “user” being an entity controlled by a set of users and/or an automated source. For example, a set of individual users federated as a community in a social network can be considered a “user.” Further to the descriptions above, a user may be provided with controls allowing the user to make an election as to both if and when systems, programs, or features described herein may enable collection of user information (e.g., information about a user's social network, social actions, or activities, profession, a user's preferences, or a user's current location), and if the user is sent content or communications from a server. In addition, certain data can be treated in one or more ways before it is stored or used, so that personally identifiable information is removed. For example, a user's identity can be treated so that no personally identifiable information can be determined for the user, or a user's geographic location can be generalized where location information is obtained (such as to a city, ZIP code, or state level), so that a particular location of a user cannot be determined. Thus, the user can have control over what information is collected about the user, how that information is used, and what information is provided to the user.

FIG. 2 is a block diagram of an example platform 120, object management engine 122, simulation engine 124, and model engine 126, according to at least one embodiment. As described above, object management engine 122, simulation engine 124, and/or model engine 126 can reside at or can otherwise be connected to platform 120 (e.g., using network 104). In other or similar embodiments, object management engine 122, simulation engine 124, and/or model engine 126 can reside at or can otherwise be connected to platform 140 (e.g., using network 104). Object management engine 122, simulation engine 124, and/or model engine 126 can be connected to memory 250, in some embodiments. Memory 250 can correspond to one or more portions of data store 110, in some embodiments. In additional or alternative embodiments, memory 250 can correspond to any memory of, connected to, or accessible by a component of system 100.

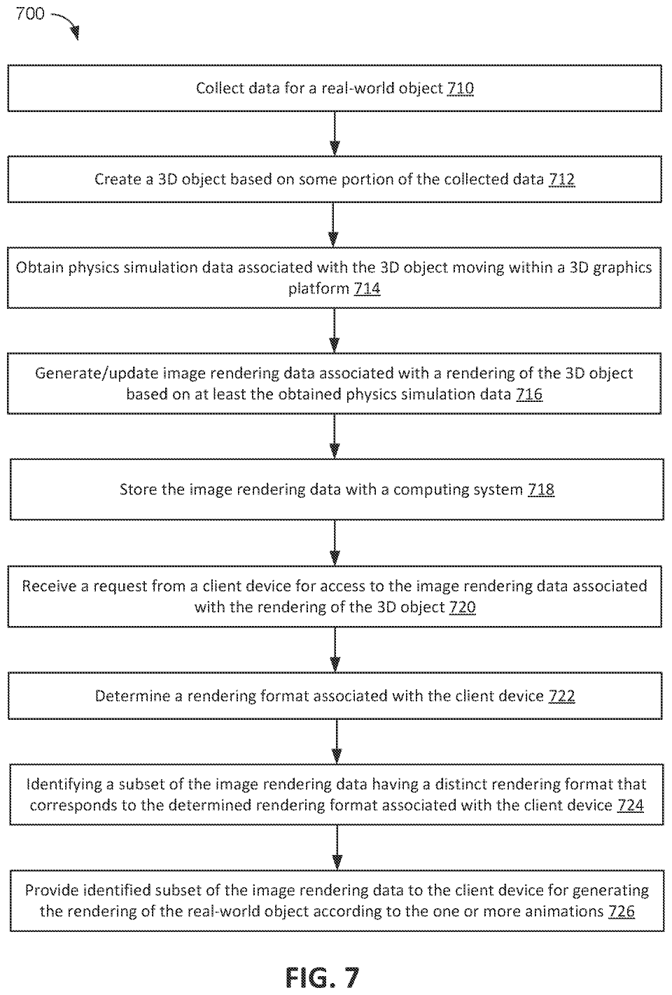

As described above, platform 120 can provide users with access to a rendering of a simulated representation of a real-world object. A real-world object can include or otherwise correspond to real-world clothing object, such as a clothing item, a jewelry item, an accessory item, or any other such item. As noted herein, the real-world object can correspond to any type of object, in accordance with embodiments of the present disclosure. In some embodiments, platform 120 can be or otherwise correspond to a clothing services platform. Users can access the rendering of the real-world clothing objects worn by an avatar associated with the user using a client device 102 connected to the clothing services platform, as described herein. In other or similar embodiments platform 120 can be or otherwise correspond to a 3D object design and development platform. Further details regarding such embodiments are described with respect to FIG. 7 below.

It should be noted that although some embodiments of the present disclosure may be described with respect to providing a rendering of a real-world clothing object with a virtual avatar and other embodiments of the present disclosure may be described with respect to providing a model file to a client device for execution to generate a rendering of a real-world object according to one or more animations, aspects of each embodiment can be applied to other embodiments of the present disclosure. For example, techniques associated with providing the rendering of the real-world clothing object can be applied to embodiments associated with providing the model file to the client device for execution to generate a rendering of a real-world object according to one or more animations, and vice versa.

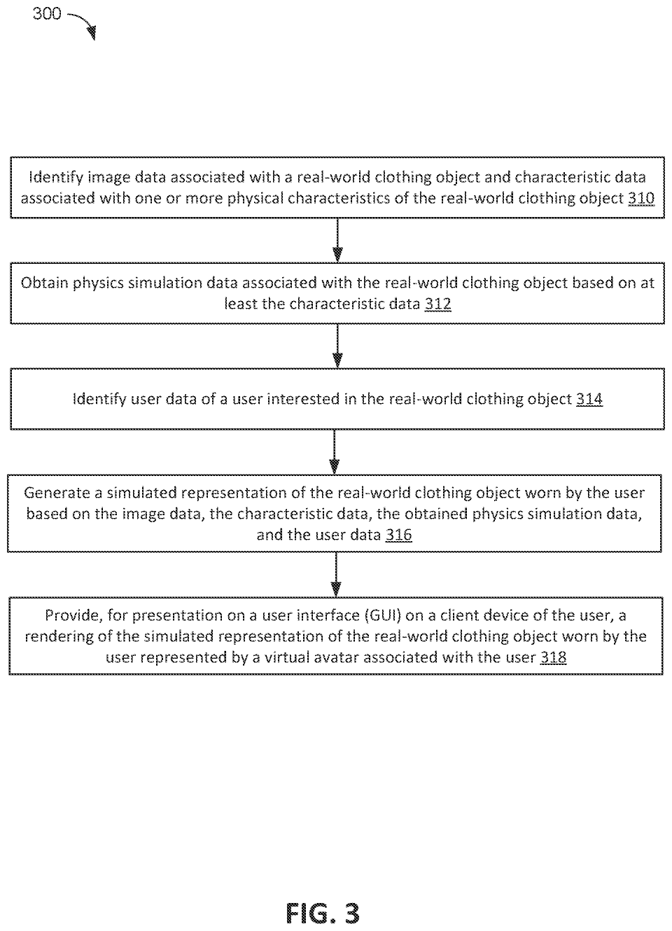

FIG. 3 illustrates a flow diagram for an example method 300 for providing a rendering of a simulated representation of a real-world object worn by a user, according to at least one embodiment. In some embodiments, method 300 can be performed by platform 120. For example, one or more operations of method 300 can be performed by object management engine 122, simulation engine 124, and/or model engine 126, in some embodiments. Method 300 may be performed by one or more processing units (e.g., CPUs and/or GPUs), which may include (or communicate with) one or more memory devices. In at least one embodiment, method 300 may be performed by multiple processing threads (e.g., CPU threads and/or GPU threads), each thread executing one or more individual functions, routines, subroutines, or operations of the method. In at least one embodiment, processing threads implementing method 300 may be synchronized (e.g., using semaphores, critical sections, and/or other thread synchronization mechanisms). Alternatively, processing threads implementing method 300 may be executed asynchronously with respect to each other. Various operations of method 300 may be performed in a different order compared with the order shown in FIG. 3. Some operations of the methods may be performed concurrently with other operations. In at least one embodiment, one or more operations shown in FIG. 3 may not always be performed.

At block 310, processing logic identifies image data associated with a real-world clothing object and characteristic data associated with one or more characteristics of the real-world clothing object. In some embodiments, the image data and/or the characteristic data associated with the real-world clothing object can be provided by a user (e.g., a retailer user, distributor user, etc.) associated with platform 120. Referring back to FIG. 2, client device 102A can be associated with a first user of platform 120. The first user can be or can correspond to a retailer or distributor of clothing items, in some embodiments. Such user may be referred to herein as a “distributor user.” In some embodiments, client device 102A can provide object data 204 associated with the real-world clothing object to platform 120 (e.g., in response to a request by the distributor user). The object data 204 can include the image data and/or the characteristic data, in some embodiments. In some embodiments, the image data can include one or more images (or image frames) each depicting one or more portions of the clothing object. The image data can be generated by a camera component of or connected to client device 102A, in some embodiments. In some embodiments, the image data can include at least one of a set of 2D images depicting the clothing object, a video depicting the clothing object, and/or a set of 3D images depicting the clothing object. In one or more embodiments, the image data can be generated by a 3D scanner device. The 3D scanner device can be configured to capture 3D images of a subject. In such embodiments, the image data can include one or more 3D images depicting the clothing object. In an illustrative example, one or more images (or image frames) of the image data can depict a defect of the clothing object (e.g., a hole in the clothing object, etc.).

Characteristic data associated with a clothing object can be associated with one or more physical characteristics of the real-world clothing object. In some embodiments, the one or more physical characteristics of the clothing object can correspond to a size of the clothing object, a shape of the clothing object, a color of the clothing object, a design associated with the clothing object, one or more materials associated with the clothing object, and/or one or more defects associated with the clothing object. In some embodiments, the distributor user (or another user) associated with client device 102A can provide at least a portion of the characteristic data associated with the clothing object to client device 102A using one or more UI elements of a UI of client device 102A. In such embodiments, client device 102A can provide the characteristic data with the image data as object data 204 to platform 120. In other or similar embodiments, the distributor user can provide an identifier associated with the clothing object, such as a stock keeping unit (SKU), a universal product code (UPC), etc. associated with the clothing object to client device 102A using one or more UI elements of the UI of client device 102A. The distributor user can additionally or alternatively provide an indication of a defect of the clothing object using the one or more UI elements, in some embodiments. Client device 102A can provide identifier and/or the indication of the defect with the image data to platform 120 as object data 204, in some embodiments.

As illustrated in FIG. 2, object management engine 122 can include an image data component 212 and/or a characteristic data component 214. Image data component 212 can extract image data from object data 204 provided to platform 120 by client device 102A. Characteristic data component 210 can extract characteristic data from object data 204. In some embodiments, image data component 212 and/or characteristic data component 214 can store the extracted image data at memory 250 as image data 252 and the extracted characteristic data at memory 250 as characteristic data 254. As indicated above, in some embodiments, object data 204 can include image data 252 and may include an identifier associated with the clothing object, rather than characteristic data 254 associated with the clothing object. In such embodiments, characteristic data component 214 can obtain the characteristic data 254 associated with the clothing object from one or more other sources. For example, characteristic data component 214 can identify one or more clothing object databases that are accessible to platform 120. Such databases can be publicly accessible databases and/or privately owned databases, in some embodiments. In some embodiments, the databases can include one or more entries that include a mapping between an identifier associated with a clothing object and an indication of one or more physical characteristics associated with the clothing object. Characteristic data component 214 can parse the entries of the database(s) to identify an entry corresponding to the identifier associated with the clothing object. Characteristic data component 214 can extract data indicating the one or more physical characteristics associated with the clothing object (e.g., mapped to the identifier) from the entry and can store such extracted data at memory 250 as characteristic data 254.

At block 312, processing logic obtains physics simulation data associated with the real-world clothing object based on at least the characteristic data. The physics simulation data corresponds to one or more physical states associated with the clothing object based on a simulated physical behavior of the clothing object. As described above, platform 120 can include or can be otherwise connected to simulation engine 124. Simulation engine 124 can be, or can include a physics simulation engine that is configured to generate physics simulation data associated with a clothing object based on the simulated physical behavior of the clothing object in view of soft-body dynamics of the clothing object. The simulated physical behavior can correspond to a motion behavior associated with the clothing object and/or a draping behavior associated with the clothing object. In some embodiments, simulation engine 124 can be or can otherwise execute using PhysX® from NVIDIA Corporation, or other similar physical simulation techniques. In some embodiments, object management engine 122 can provide the characteristic data 254 and/or the image data 252 associated with the real world clothing object as input to simulation engine 124. In other or similar embodiments, simulation engine 124 can obtain the characteristic data 254 and/or the image data 252 from memory 250.

In some embodiments, simulation engine 124 can perform one or more simulations of a motion and/or a draping of the clothing object based on at least the characteristic data 254 associated with the clothing object. In some embodiments, simulation engine 124 can perform the simulation of the motion and/or the draping of the clothing object based on a simulated motion or activity of a potential user that is wearing the clothing object. The simulated behavior of the clothing object (e.g., the simulated motion and/or the simulated draping) can be represented as physics simulation data. Object management engine 122 and/or model engine 126 can obtain one or more outputs of simulation engine 124. The obtained one or more outputs can include the physics simulation data (e.g., based on the outcome of the performed simulation(s)). The physics simulation data can be stored at memory 250 as simulation data 256, in some embodiments.

Model engine 126 can generate and/or update a model file 258 associated with the clothing object based on the image data 252, the characteristic data 254, and/or the simulation data 256. As indicated above, a model file 258 can include object data associated with a 3D object that, when rendered by a rendering engine (e.g., rendering engine 162) depicts a representation of the 3D object. The object data can indicate a bone structure associated with the 3D object, a mesh for the 3D object, and/or an indication of one or more blend shapes for the 3D object. The object data can additionally or alternatively include a motion vector indicating a degree and/or a direction of a motion of a respective vertex in accordance with an animation of the 3D object. In some embodiments, model engine 126 can determine or otherwise obtain data associated with the bone structure, the mesh, and/or the blend shapes for the real-world clothing object based on the image data 252 and/or the characteristic data 254 associated with the clothing object. In additional or alternative embodiments, model engine 126 can determine or otherwise obtain data associated with the motion vector for the clothing object based on the characteristic data 254 and/or the simulation data 256 associated with the clothing object. Model engine 126 can include the obtained data described above in the model file 258, in some embodiments. It should be noted that, in some embodiments, the clothing object can be represented as a mesh that is “worn” by a virtual avatar. In such embodiments, model engine 126 can determine or otherwise obtain data associated with the mesh for the clothing object based on the image data 252 and/or the characteristic data 254 of the clothing object, as described above. In some embodiments, model engine 126 can store model file 258 at memory 250.

Referring back to FIG. 3, at block 314, processing logic identifies user data of a user interested in the real-world clothing object. In some embodiments, platform 120 can receive a request from a client device 102 (e.g., client device 102B) associated with a second user of platform 120 to access a rendering of a real-world clothing object associated with a distributor user. In some embodiments, the request can include an indication of the second user (also referred to herein as the “requesting user”) and an indication of the clothing object. In an illustrative example, platform 120 can provide an application to client device 102B that is accessible to the requesting user using a UI of client device 102B. The application can provide an indication of each clothing object associated with one or more distributor users of platform 120. In some embodiments, the application can be or correspond to a catalog of clothing objects hosted by platform 120. The requesting user can engage with one or more UI elements of the UI associated with the application to provide a selection of a clothing object of interest to the requesting user. Client device 102B can transmit the request to platform 120 (e.g., using network 104) in response to the user selection.

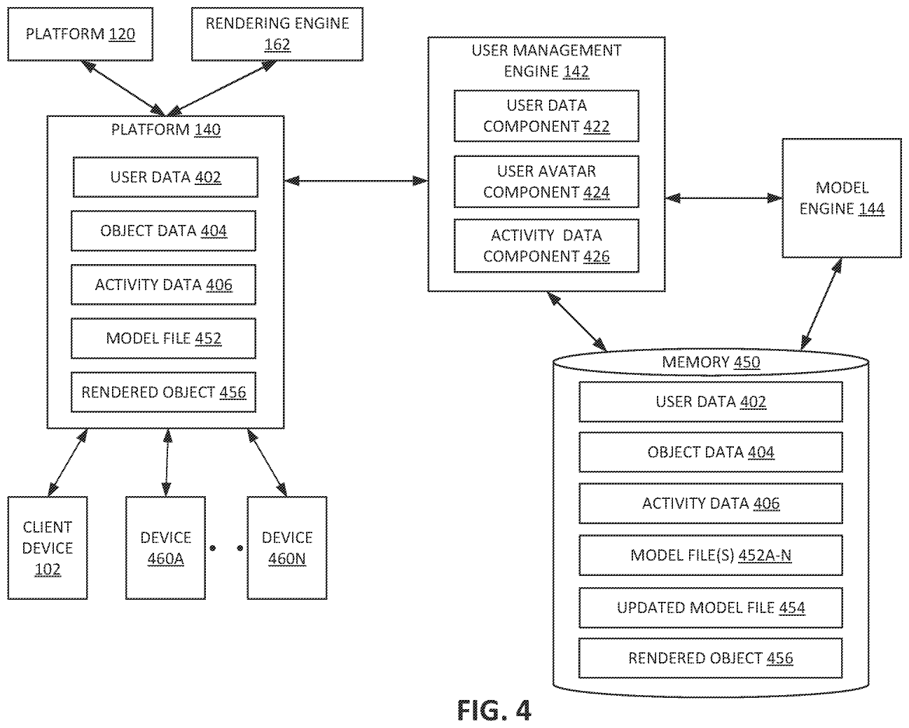

As described above, platform 140 can be or otherwise correspond to a 3D graphics collaboration platform. In some embodiments, platform 140 can provide a user with access to a rendering of a virtual avatar associated with the user. Platform 140 can generate or otherwise obtain a model file that, when rendered (e.g., by rendering engine 162) depicts the virtual avatar associated with the user. Further details regarding platform 140 and obtaining a model file for rendering a virtual avatar associated with a user are described with respect to FIGS. 4 and 5 below.

In some embodiments, platform 140 can provide platform 120 with access to a model file for rendering an avatar associated with the requesting user described above. In an illustrative example, platform 120 can provide an identifier of the requesting user (or client device 102B) to platform 140. Platform 140 can identify a model file associated with a virtual avatar for the requesting user and can provide the identified model file to platform 120 (e.g., using network 104). As described above, platform 120 can be the same platform as platform 140, in some embodiments. In such embodiments, platform 120 can access the model file (e.g., using memory 250 or another memory). In other or similar embodiments, platform 120 can provide model file 258 to client device 102B and platform 140 can provide the model file associated with the virtual avatar of the requesting user (e.g., model file 452 described below) to client device 102B (e.g., using network 104).

Referring back to FIG. 3, at block 316, processing logic generates a simulated representation of the real-world clothing object, worn by the user, based on the image data, the characteristic data, the obtained physics simulation data, and the user data. As described above, model file 258 can be generated based on image data 252, characteristic data 254, and/or simulation data 256. Platform 120 can provide model file 258 to rendering engine 162 (e.g., at server machine 160 and/or at client device 102B) and rendering engine 162 can execute model file 258 to generate the rendering of the clothing object. In some embodiments, platform 120 and/or platform 140 can provide model file 452 (e.g., associated with the virtual avatar of the requesting user) to rendering engine 162 (e.g., with model file 258). Rendering engine 162 can execute model file 452 (e.g., with model file 258) to generate the rendering of the virtual avatar wearing the real-world clothing object. It should be noted that in some embodiments, model engine 126 and/or model engine 144 can generate a single model file that includes object data associated with the real-world clothing object worn by the virtual avatar, as described above. Such model file can be provided to rendering engine 162 and rendering engine 162 can generate the rendering of the virtual object wearing the real-world clothing object by executing such model file.

At block 318, processing logic provides, for presentation on a user interface (UI) on a client device of the user, a rendering of the simulated representation of the real-world clothing object worn by the user represented by a virtual avatar associated with the user. In some embodiments, platform 120 and/or platform 140 can provide the rendering of the simulated representation of the clothing object worn by the user represented by the virtual avatar to client device 102B. Client device 102B can provide the rendering to the requesting user using a UI of client device 102B, in accordance with previously described embodiments. As described above, in some embodiments, platform 120 and/or platform 140 can provide model file 258 and/or model file 452 to client device 102B for rendering by rendering engine 162 at client device 102B. Rendering engine 162 can execute the model files 258, 456, as described above, and client device 102B can provide the generated rendering to the requesting user using the UI of client device 102B.

In some embodiments, the UI of client device 102B can include one or more UI elements (e.g., buttons, etc.) that can correspond to a movement of the clothing object and/or the virtual avatar. In some embodiments, the requesting user can engage with the UI elements to cause the clothing object and/or the virtual avatar to move. Client device 102B can transmit an indication of the motion to rendering engine 162 and/or platform 120, in some embodiments. Rendering engine 162 can update the rendering of the clothing object worn by the virtual avatar in accordance with the motion, as described above, and client device 102B can provide the updated rendering to the requesting user using the UI. In some embodiments, one or more UI elements of the UI can correspond to an environmental condition of a virtual environment that includes the virtual avatar wearing the clothing object. The requesting user can engage with a UI element to change a condition (e.g., a lighting condition, a weather condition, etc.) of the virtual environment of the virtual avatar. Rendering engine 162 can update the rendering of the virtual avatar wearing the clothing object based on the changed condition associated with the UI element and client device 102B can provide the updated rendering to the requesting user using the UI of client device 102B, as described above. The renderings (and/or updated renderings) of the clothing object can provide the requesting user with an accurate representation of a behavior of the clothing object when worn by the user (e.g., in one or more environments). As described above, the clothing object can include one or more defects (e.g., holes, etc.). The rendering of the clothing object as worn by the virtual avatar can provide, to the requesting user, an accurate representation of the defect of the clothing object when worn by the user.

In one or more additional embodiments, platform 120 can determine a comfort level associated with the clothing object. The comfort level can indicate a level or degree of comfort of the clothing object in view of a size of the clothing object and dimensions of the virtual avatar of the user. In some embodiments, platform 120 can determine the comfort level based on the simulation data 256 and/or data associated with the requesting user (e.g., as described below). Platform 120 can provide an indication of the comfort level to the requesting user using the UI of client device 102B, as described herein.

FIG. 4 is a block diagram of an example user management engine 142 and an example model engine 144, according to at least one embodiment. As described above, user management engine 142 and/or model engine 144 can reside at or otherwise be connected to platform 140 (e.g., using network 104). In other or similar embodiments, user management engine 142 and/or model engine 144 can reside at or otherwise be connected to platform 120 (e.g., using network 104). User management engine 142 and/or model engine 126 can be connected to memory 450, in some embodiments. Memory 450 can correspond to one or more portions of data store 110, in some embodiments. In additional or alternative embodiments, memory 450 can correspond to any memory of, connected to, or accessible by a component of system 100. In some embodiments, one or more portions of memory 450 can be included at memory 250.

As described above, platform 140 can provide users with access to renderings of one or more virtual avatars. In some embodiments, platform 140 can be or can otherwise correspond to a 3D graphics collaboration platform. In some embodiments, a virtual avatar can be rendered to include one or more characteristics, as provided by the user of the platform. The one or more characteristics can be included with or otherwise indicated by user data 402. User data 402 can include data associated with a user that is provided by or otherwise received by a client device 102 associated with the user. In some embodiments, the virtual avatar can be rendered to include one or more characteristics that are the same or similar to characteristics of the user (e.g., hair color, eye color, etc.). In such embodiments, the user data 402 can include an indication of one or more characteristics of the user, as provided using client device 102. The indication of the one or more characteristics of the user can include image data for an image depicting the user, or other data that indicates the characteristics of the user, in some embodiments. In other or similar embodiments, the virtual avatar can be rendered as a character or object based on characteristics provided by the user. In such embodiments, user data 402 can include an indication of the characteristics of the character or object, as provided using client device 102.

As illustrated in FIG. 4, user management engine 142 can include a user data component 422, a user avatar component 424, and/or an activity data component 426. User data component 422 of user management engine 142 can obtain user data 402 from platform 120 and, in some embodiments, can store the user data 402 at memory 450. In some embodiments, user data component 422 can store a mapping between the obtained user data 402 and an identifier associated with the user and/or the client device 102 associated with the user at memory 450.

In some embodiments, an artist or developer of a 3D object, such as the virtual avatar, can provide object data 404 associated with a virtual avatar to platform 140 (e.g., using a client device associated with the artist or developer). The object data 404 can include rendering data for default characteristics for the avatar, as defined by the artist or the developer. For example, the object data 404 can include an indication of a bone structure and a mesh (e.g., a polygon mesh) for the avatar, an indication of an assignment of one or more bones of the bone structure to a vertex of the mesh, and/or an indication of one or more default characteristics (e.g., indicated by default texturing coordinates, color data, etc.) for rendering the avatar. In some embodiments, platform 140 can store the object data 404 at memory 450. User avatar component 424 of user management engine 142 can update object data 404 to include a mapping between one or more characteristics of the virtual avatar associated with the user of platform 140 to corresponding data of object data 404. For example, user avatar component 424 can update object data 404 to include a mapping between one or more texturing coordinates and/or color data associated with a portion of the virtual avatar including the avatar's eyes and an eye color of the user, as indicated by user data 402.

It should be noted that in other or similar embodiments, object data 404 and/or characteristics of a virtual avatar can be provided by another system other than platform 140. For example, a computing system other than platform 140 can provide a model file 452 for rendering the virtual avatar using rendering engine 162. The model file 452 can include object data 404 and/or characteristics of the virtual avatar, in some embodiments. In other or similar embodiments, a model engine 144 can generate or update the model file 452 based on the user data 402 and/or the object data 404 obtained from platform 140. The model file 452 can include or otherwise correspond to a set of instructions that, when executed by a rendering engine (e.g., rendering engine 162) can depict a virtual avatar having one or more characteristics, which as the characteristics indicated by user data 402. In some embodiments, the model file 452 can include data or instructions relating to 3D modeling (e.g., creating a 3D mesh or wireframe model based on parameters defined by user data 402, object data 404, and/or other data), texturing (e.g., applying textures to the 3D model, including skin tone, hair color, eye color, and other surface details), rigging (e.g., creating a skeleton-like structure withing the 3D model, allowing the avatar to be animated and/or move realistically), and/or animation (e.g., relating to specific actions or gestures of the avatar), among other types of data or instructions.

In some embodiments, platform 140 can obtain model file 452 from model engine 144 and/or at memory 450. Platform 140 can obtain model file 452 in response to a request, in some embodiments. For example, platform 140 can obtain model file 452 in response to a request from platform 120. As described above, platform 120 can request model file 452 from platform 140 in response to a request from a user of platform 120 for a rendering of a real-world clothing object as worn by a virtual avatar of the user. In response to obtaining the model file 452, platform 120 can provide the model file 452 to rendering engine 162, in some embodiments. Rendering engine 162 can execute the model file 452 to generate the rendering of the virtual avatar. In some embodiments, platform 120 and/or rendering engine 162 can provide the rendering of the virtual avatar (e.g., rendered object 456) to client device 102, as described herein. In other or similar embodiments, platform 140 can provide an obtained model file 452 to platform 120. Platform 120 can provide the model file 452 (e.g., with model file 258) to rendering engine 162 (or another rendering engine) to obtain the rendering of the real-world clothing object as worn by a virtual avatar of the user, as described above.

In some embodiments, user management engine 142 and/or model engine 144 can update user data 402 and/or a model file 452 associated with a virtual avatar associated with a user of platform 140 based on activity data 406 obtained for the user. Activity data 406 can include any data that represents an activity (e.g., a physical activity, etc.) or motion performed by a user and detected by one or more devices 460 associated with the user. User management engine 142 can update user data 402 and/or object data 404 based on the activity data 406, in some embodiments, and model engine 144 can update model file 452 based on the updated user data 402 and/or object data 404, as described below with respect to FIG. 5. The updated model file 454 can be stored at memory 450 and platform 140 can provide the updated model file 454 to platform 120 and/or rendering engine 162, as described above.

FIG. 5 illustrates a flow diagram for an example method 500 for updating a virtual avatar associated with a user, according to at least one embodiment. In some embodiments, method 500 may be performed by platform 140. In one or more embodiments, method 500 can be performed by user management engine 142 and/or model engine 144. Method 500 may be performed by one or more processing units (e.g., CPUs and/or GPUs), which may include (or communicate with) one or more memory devices. In at least one embodiment, method 500 may be performed by multiple processing threads (e.g., CPU threads and/or GPU threads), each thread executing one or more individual functions, routines, subroutines, or operations of the method. In at least one embodiment, processing threads implementing method 500 may be synchronized (e.g., using semaphores, critical sections, and/or other thread synchronization mechanisms). Alternatively, processing threads implementing method 500 may be executed asynchronously with respect to each other. Various operations of method 500 may be performed in a different order compared with the order shown in FIG. 5. Some operations of the methods may be performed concurrently with other operations. In at least one embodiment, one or more operations shown in FIG. 5 may not always be performed.

At block 510, processing logic receives image data associated with a user of a platform and clothing size data associated with the user. The user can be a user of platform 120, platform 140, and/or another platform, in some embodiments. In some embodiments, the user can be associated with a virtual avatar of platform 140 (or another platform). Processing logic can receive the image data and/or the clothing size data from a client device 102 associated with the user. The image data and/or the clothing size data can be provided with user data 402 to platform 140, in some embodiments. In other or similar embodiments, the image data and/or the clothing size data can be provided to platform 140 separately from user data 402. In yet other or similar embodiments, the image data and/or the clothing size data can be received by platform 140 from platform 120.

At block 512, processing logic obtains activity data associated with one or more physical activities performed by the user. In some embodiments, platform 140 can obtain the activity data from one or more devices 260 associated with the user. A device 260 can include any type of device that is configured to monitor or otherwise obtain data indicating an activity or motion of a user. The device can include a wearable device or a non-wearable device, in some embodiments. In some embodiments, a device 260 can include, but is not limited to, a wrist-worn device (e.g., a smart watch), a fitness band device (e.g., worn on other areas of the body), a smart clothing device (e.g., a garment with one or more sensors and/or conductive fabric), a smart show device (e.g., shoes equipped with sensors and/or motion trackers), virtual reality (VR) fitness tracking device, and so forth. In some embodiments, device 260 can include or be connected to one or more types of sensors (e.g., accelerometers, gyroscopes, heart rate monitors, GPS modules, etc.) that can monitor a user's activity and can generate activity data (e.g., activity data 406) indicating the monitored activity. Device 260 can provide the generated activity data 406 to platform 140 (e.g., using network 104). In other or similar embodiments, a user can provide an indication of an activity or motion performed by the user to platform 140 (e.g., using a UI of client device 102). For example, the user can engage with one or more UI elements of the UI of client device 102 to provide platform 140 with an indication of a running event that the user participated in.

Activity data 406 can include or otherwise indicate a step count associated with an activity or motion performed by a user, a distance traveled by a user during the performed activity or motion, a time period that the user performed the activity or motion, a number of calories burned during the performance of the activity or motion, a heart rate of the user during the performance of the activity or the motion, a sleep pattern associated with the user, a number of stairs climbed by the user and/or an elevation change of the user during a performed activity or motion, a time period during which the user remained inactive or sedentary, a stress level of the user during a period of activity or inactivity, and so forth. Activity data component 426 can obtain the activity data 406 and can store the activity data 406 at memory 450, in some embodiments.

It should be noted that device 260 can provide platform 140 with activity data 406 at the request of the user associated with devices 260 and/or client device 102. For example, during or after an initialization of devices 206, the user can set one or more settings associated with the devices 460 indicating permission to provide activity data 406 to platform 140. User can change the one or more settings (e.g., to revoke permission to provide activity data 406) to platform 140 at any time. Immediately, or soon after, detecting that the user has changed the one or more settings, devices 460 can terminate transmission of activity data 406 to platform 140. In some embodiments, a device 460 can transmit a notification to platform 140 indicating the revocation of the permission. In some embodiments, platform 140 can remove (e.g., erase, destroy, etc.) activity data 406 associated with the user from memory 450 and/or any other memory of system 100.

At block 514, processing logic updates an avatar associated with the user based on the clothing size data associated with the user and the obtained activity data. In some embodiments, processing logic can determine updated characteristics associated with a virtual avatar based on the activity data 406 and the existing characteristics of the virtual avatar (e.g., as indicated by user data 402 and/or object data 404). The updated characteristics can include, in some embodiments, updated sizing and/or modeling characteristics for a 3D model of the virtual avatar. In some embodiments, the updated characteristics can be obtained based on one or more outputs of a machine learning model that is trained to predict, based on given data (e.g., user data 402, object data 404, image data, etc.) and given activity data of a past or current time period, a size or shape of a 3D model associated with a virtual avatar at one or more future time periods based on the activity data. The model can additionally or alternatively predict a future clothing size associated with one or more clothing objects based on the size or shape of the 3D model at the one or more future time periods. Platform 140 can provide user data 402, object data 404, activity data 406, image data (e.g., depicting the user), and/or other types of data as input to the machine learning model. Platform 140 can obtain one or more outputs of the machine learning model, the one or more outputs indicating an updated size or shape of the 3D model based on the activity or motion of the given activity data 406 at one or more future time periods. For example, the one or more outputs can indicate a size or shape of the 3D model if the activity or motion of the given activity data 406 continues for one week, one month, multiple months, one year, etc. Platform 140 can extract the updated size or shape of the 3D model (e.g., at a particular future time period) from the one or more outputs of the machine learning model as characteristic data associated with the avatar, in some embodiments. In additional or alternative embodiments, the one or more outputs can indicate one or more clothing sizes associated with a real-world clothing item. Platform 140 can extract the one or more clothing sizes from the one from the one or more outputs, in some embodiments. In some embodiments, platform 140 can provide the extracted characteristics to activity data component 426. In some embodiments, activity data component 426 and/or user avatar component 424 can update user data 402 and/or object data 404 based on the extracted characteristics, in some embodiments. It should be noted that the updated characteristics can be obtained according to other techniques, in other or similar embodiments.

At block 516, processing logic provides a rendering of the updated avatar associated with the user for presentation using a UI of a client device (e.g., client device 102) associated with the user. Model engine 144 can update model file 452 to obtain updated model file 454 based on the updated user data 402 and/or object data 404, in some embodiments. Platform 140 can provide the updated model file 454 to platform 120 and/or rendering engine 162 to provide the rendering of the updated avatar for presentation using the UI of client device 102, as described above. In some embodiments, platform 140 and/or platform 120 can provide an indication of the clothing size associated with a real-world clothing object worn by the updated avatar for presentation using the UI (e.g., with the rendering of the updated avatar).

It should be noted that platform 140 can update a rendering of a virtual avatar based on data other than activity data 406. For example, a user can provide medical data to platform 140 indicating a pregnancy of the user. Platform 140 can update characteristics of a virtual avatar associated with the user based on stages of pregnancy at different future time periods, as described herein. The updated rendering of the avatar can be provided based on the updated characteristics, in some embodiments.

FIG. 6 is a block diagram of a system 600 including an AI server 180, according to at least one embodiment. The system architecture 600 (also referred to as “system” herein) includes a data store 610, a generative model 620 provided by AI server 180, a server machine 640 with a query tool (QT) 601, one or more client devices 120, and/or other components connected to a network 650. In some embodiments, network 650 may be a public network (e.g., the Internet), a private network (e.g., a local area network (LAN) or wide area network (WAN)), a wired network (e.g., Ethernet network), a wireless network (e.g., an 802.11 network or a Wi-Fi network), a cellular network (e.g., a Long Term Evolution (LTE) network), and/or the like. In some embodiments, network 650 may include routers, hubs, switches, server computers, and/or a combination thereof.

In some embodiments, any of AI server 180, server machine 640, and/or client device(s) 102 may include a desktop computer, a laptop computer, a smartphone, a tablet computer, a server, a scanner, or any suitable computing device capable of performing the techniques described herein. In some embodiments, any of server machine 540 and/or client device(s) 102 may be (and/or include) one or more components or engines of system 100 of FIG. 1.

In some embodiments, data store 610 (database, data warehouse, etc.) may store any suitable raw and/or processed data. For example, data store 610 can store image data 252, characteristic data 254, simulation data 256, user data 402, object data 404, activity data 406, and so forth.

System 600 may further include a data manager (DM) 660 that may be any application configured to manage data transport to and from data store 610, e.g., retrieval of data and/or storage of new data, indexing data, arranging data by user, time, type of activity to which the data is related, associating the data with keywords, and/or the like. DM 660 may collect data associated with one or more 3D objects for rendering using rendering engine 162. DM 560 may collect, transform, aggregate, and archive such data in data store 610. In some embodiments, DM 660 may support a suitable software that, with user's consent, resides on client device(s) 102 and/or devices 460 and tracks user activities. For example, the DM-supported software may capture user-generated content and convert the captured content into a format that can be used by various content destinations, e.g., QT 601. In some embodiments, the DM-supported software may be a code snippet integrated into user's browsers/apps and/or websites visited by the user. Generating, tracking, and transmitting data may be facilitated by one or more libraries of DM 660. In some embodiments, data may be transmitted using messages in the JSON format. A message may include a user digital identifier, a timestamp, name and version of a library that generated the message, page path, user agent, operating system, settings. A message may further include various user traits, which should be broadly understood as any contextual data associated with user's activities and/or preferences. DM 660 may track different ways the same user DM 660 may facilitate data suppression/deletion in accordance with various data protection and consumer protection regulations. DM 660 may validate data, convert data into a target format, identify and eliminate duplicate data, and/or the like. DM 660 may aggregate data, e.g., identify and combine data associated with a given user in the user's profile (user's persona), and storing the user's profile on a single memory partition.

Data store 610 may be implemented in a persistent storage capable of storing files as well as data structures to perform identification of data, in accordance with embodiments of the disclosure. Data store 610 may be hosted by one or more storage devices, such as main memory, magnetic or optical storage disks, tapes, or hard drives, network-attached storage (NAS), storage area network (SAN), and so forth. Although depicted as separate from the server machine 640, data store 610 may be part of server machine 640, and/or other devices. In some embodiments, data store 610 may be implemented on a network-attached file server, while in other embodiments data store 610 may be implemented on some other types of persistent storage, such as an object-oriented database, a relational database, and so forth, that may be hosted by a server machine 640 or one or more different machines coupled to server machine 640 using network 650.

Server machine 640 may include QT 601 configured to perform automated identification and facilitate retrieval of relevant and timely contextual information for quick and accurate processing of user queries by generative model 620, as disclosed herein. In some embodiments, QT 601 may be implemented by object management engine 122. It can be noted that a user's request to access a rendering of a real-world clothing object worn by a virtual avatar associated with the user can be formed into a query that uses QT 601 in some embodiments. Using network 650, QT 601 may be in communication with one or more client devices 120, AI server 180, and/or data store 610, e.g., using DM 660. Communications between QT 601 and AI server 180 may be facilitated by GM API 602. Communications between QT 601 and data store 610/DM 660 may be facilitated by DM API 604. Additionally, GM API 602 may translate various queries generated by QT 601 into unstructured natural-language format and, conversely, translate responses received from generative model 620 into any suitable form (including any structured proprietary format as may be used by QT 501). Similarly, DM API 604 may support instructions that may be used to communicate data requests to DM 660 and formats of data received from data store 610 using DM 660.

A user (e.g., participant, etc.) may interact with QT 601 using a user interface (UI) 642. In some embodiments, UI 642 may be the same or similar to a UI provided by platform 120 and/or platform 140. In some embodiments, UI 642 may be implemented in a UI provided by platform 120 and/or platform 140. For example, UI 642 can be a UI element of a UI provided by platform 120 and/or platform 140. UI 642 may support any suitable types of user inputs, e.g., speech inputs (captured by a microphone), text inputs (entered using a keyboard, touchscreen, or any pointing device), camera (e.g., for recognition of sign language), and/or the like, or any combination thereof. UI 642 may further support any suitable types of outputs, e.g., speech outputs (using one or more speaker), text, graphics, and/or sign language outputs (e.g., displayed using any suitable screen), file for a word editing application, and/or the like, or any combination thereof. In some embodiments, UI 642 may be a web-based UI (e.g., a web browser-supported interface), a mobile application-supported UI, or any combination thereof. UI 642 may include selectable items. In some embodiments, UI 642 may allow a user to select from multiple (e.g., specialized in particular knowledge areas) generative models 620. UI 642 may allow the user to provide consent for QT 601 and/or generative model 620 to access user data previously stored in data store 610 (and/or any other memory device), process and/or store new data received from the user, and the like. UI 642 may allow the user to withhold consent to provide access to user data to QT 601 and/or generative model 620. In some embodiments, user inputs entered using UI 642 may be communicated to QT 601 using a user API 644. In some embodiments, UI 642 and user API 644 may be located on client device 102 that the user is using to QT 601. For example, an API package with user API 644 and/or user interface 642 may be downloaded to client device 102. The downloaded API package may be used to install user API 644 and/or user interface 642 to enable the user to have two-way communication with QT 601.

QT 601 may include a user query analyzer 603 to support various operations of this disclosure. For example, user query analyzer 603 may receive a user input, e.g., user query, and generate one or more intermediate queries to generative model 620 to determine what type of user data GM 620 might need to successfully respond to user input. Upon receiving a response from GM 620, user query analyzer 603 may analyze the response, form a request for relevant contextual data for DM 660, which may then supply such data. User query analyzer 603 may then generate a final query to GM 620 that includes the original user query and the contextual data received from DM 660. In some embodiments, user query analyzer 603 may itself include a lightweight generative model that may process the intermediate query(ies) and determine what type of contextual data may have to be provided to GM 620 together with the original user query to ensure a meaningful response from GM 620.

QT 601 may include (or may have access to) instructions stored on one or more tangible, machine-readable storage media of server machine 640 and executable by one or more processing devices of server machine 640. In one embodiment, QT 601 may be implemented on a single machine (e.g., as depicted in FIG. 5). In some embodiments, QT 601 may be a combination of a client component and a server component. In some embodiments QT 601 may be executed entirely on the client device(s) 102. Alternatively, some portion of QT 601 may be executed on a client computing device while another portion of QT 601 may be executed on server machine 640.

FIG. 7 illustrates a flow diagram for an example method of providing a rendering of a real-world object, according to at least one embodiment. In some embodiments, method 700 can be performed by platform 120. For example, one or more operations of method 700 can be performed by object management engine 122, simulation engine 124, and/or model engine 126, in some embodiments. Method 700 may be performed by one or more processing units (e.g., CPUs and/or GPUs), which may include (or communicate with) one or more memory devices. In at least one embodiment, method 700 may be performed by multiple processing threads (e.g., CPU threads and/or GPU threads), each thread executing one or more individual functions, routines, subroutines, or operations of the method. In at least one embodiment, processing threads implementing method 700 may be synchronized (e.g., using semaphores, critical sections, and/or other thread synchronization mechanisms). Alternatively, processing threads implementing method 700 may be executed asynchronously with respect to each other. Various operations of method 700 may be performed in a different order compared with the order shown in FIG. 7. Some operations of the methods may be performed concurrently with other operations. In at least one embodiment, one or more operations shown in FIG. 7 may not always be performed.

At block 710, processing logic collects data for a real-world object (e.g., a real-world clothing object, another type of real-world object, etc.). The data can indicate one or more physical characteristics of the real-world object. In some embodiments, the data can include image data and/or characteristic data associated with the real-world object, as described above. The real-world object can be provided by a user (e.g., a designer, a developer, etc.) associated with platform 120, in accordance with previously described embodiments. The one or more physical characteristics of the real-world object can correspond to at least one of a size of the real-world object, a shape of the real-world object, a design associated with the real-world object, one or more materials associated with the real-world object, or one or more defects associated with the real-world object, as described herein.

In some embodiments, the identified data can be image data that includes a set of 2D images, a video, a set of 3D images, etc. depicting the real-world object. Processing logic can provide the image data as input to an artificial intelligence (AI) model that is trained to predict, based on given image data, one or more physical characteristics associated with objects depicted in the given image. The AI model can be trained based on a data set including historical image data and historical characteristic data for one or more objects depicted in an image of the historical image data, in some embodiments. In one example, the data set can include a subset of training inputs and a subset of target outputs. The subset of training inputs can include the historical image data. The subset of training inputs can indicate, for one or more objects depicted in an image of the historical image data, one or more physical characteristics associated with the one or more objects. Processing logic can obtain one or more outputs of the AI model and can extract, from the obtained one or more outputs, characteristic data indicating the one or more physical characteristics of the real-world object depicted in an image of the given image data. In some embodiments, the one or more outputs can include one or more sets of characteristic data and, for each set of characteristic data, an indication of a level of confidence that the respective set of characteristic data corresponds to the real-world object depicted in an image of the given image data. Processing logic can extract the characteristic data from the one or more outputs by identifying the set of characteristic data having a level of confidence that satisfies one or more confidence criteria (e.g., exceeds a threshold level of confidence, is larger than other levels of confidence for other sets of characteristic data, etc.). In some embodiments, processing logic can use the extracted characteristic data to obtain physics simulation data associated with the real-world object, in accordance with embodiments described herein.

At block 712, processing logic can create a 3D object based on some portion of the collected data. In some embodiments, processing logic can create the 3D object based an output of a NeRF engine, as described above. For example, processing logic can provide the collected data as input to a NeRF engine that generates data (e.g., of a model file) for the 3D object based on the given input data. As indicated above, the NeRF engine can include, correspond to, or implement techniques of NGP Instant NeRF™ by NVIDIA Corporation.

At block 714, processing logic obtains physics simulation data associated with the 3D object moving within a 3D graphics platform. The 3D graphics platform can be a 3D graphics collaboration platform, such as the Omniverse™ Platform by NVIDIA Corporation. The physics simulation data can correspond to one or more physical states associated with the real-world object based on a simulated physical behavior of the real-world object, as described above. In some embodiments, processing logic can obtain the physics simulation data by providing the data associated with the real-world object as input to a physics simulation engine. The physics simulation engine is configured to generate physics simulation data associated with the real-world object based on the simulated physical behavior of the real-world object in view of soft-body dynamics and/or rigid-body dynamics associated with the real-world object. In some embodiments, processing logic can provide the characteristic data extracted from the output(s) of the AI model as input to the physics simulation engine, as described above. In some embodiments, the physics simulation engine can be or can otherwise execute using PhysX® from NVIDIA Corporation.

In some embodiments, a user of platform 120 can provide an indication (e.g., via client device 102) of one or more simulations that are to be simulated by physics simulation engine. In an illustrative example, a designer or developer can be creating or otherwise customizing an animation of a clothing object on a character or object in a virtual environment (e.g., a video game environment, etc.). The real-world clothing object can serve as a base for the animated clothing object for the character or the object. The designer or developer can provide, via client device 102, an indication of one or more movements of the character or the object (e.g., according to abilities of the character or object in the virtual environment) and client device 102 can provide the indication to platform 120 (e.g., via network 104). The physics simulation engine can generate physics simulation data based on a simulation of the indicated movements.

At block 716, processing logic generates and/or updates image rendering data associated with generating a rendering of the real-world object based on the obtained physics simulation data. The updated rendering data can include one or more model files associated with generating the rendering of the real-world object. The one or more files include information pertaining to one or more animations for the rendering of the real-world object based on the obtained physics simulation data. In some embodiments, processing logic can generate and/or update the model file based on the data associated with the real-world object and/or the physics simulation data obtained for the real-world object. As described above, in some embodiments, image data associated with the real-world object can be provided to a neural radiance field (NeRF) engine that is configured to generate a model file to render the real-world object as a 3D object. The NeRF engine can generate the model file for the 3D object based on 2D images, in some embodiments. In some embodiments, the NeRF engine can include, correspond to, or implement techniques of Neural Graphics Primitives (NGP) Instant NeRF™ by NVIDIA Corporation. In some embodiments, the model files can be additionally or further updated to include instructions associated with an animation of the real-world object according to the simulations performed by the physics simulation engine, in accordance with embodiments described herein.

In some embodiments, each model file associated with generating a rendering the real-world object can have a distinct rendering format. As provided above, a rendering format of a model file represents or otherwise defines data organization and compression techniques that are to be applied by a rendering engine to data and/or instructions of a model file to generate the rendering of the animation of a 3D object. In some instances, client devices and/or applications (or application instances) executing using the client devices can be configured to execute model files having particular rendering formats (e.g., according to a type of hardware components of the client devices, etc.). Each model file associated with generating the rendering of the animation of the real-world object that is updated by the platform can have a distinct rendering format. Accordingly, the model files updated by the platform can be executed by rendering engines associated with client devices and/or applications that support different types of model file rendering formats. Examples of model file rendering formats include, but are not limited to a graphics library transmission format binary file format (e.g., GLB format), a Filmbox (FBX) format, a geometry definition file format (e.g., OBJ format), a universal scene description-based format (e.g., USD format, USDZ format, etc.), a standard tessellation language (STL), a standard for the exchange of product data (STEP) format, a collaborative design activity (COLLADA) format, and any other such formats for model files.

At block 718, processing logic stores the image rendering data with a computing system. In some embodiments, processing logic can store the model files at a memory associated with platform 120. For example, processing logic can store the model files as model files 258A-N at memory 250 and/or as model files 452A-N at memory 450. In some embodiments, processing logic can store an indication of the rendering format associated with each model file at memory 250 and/or memory 450.

It should be noted that embodiments the present disclosure provide that rendering data can include one or more model files for generating the rendering of the real-world object. However, rendering data can include any type of data used to generate the rendering of the real-world object. For example, the rendering data can include a data of a data structure (e.g., residing at memory 250 and/or memory 450) that is used to generate the rendering of the real-world object. In another example, the rendering data can include data that is referenced by a model file to generate the rendering of the real-world object.

At block 720, processing logic receives a request from a client device for access to the image rendering data associated with the rendering of the 3D object. At block 722, processing logic determines a rendering format associated with the client device. In some embodiments, an indication of the rendering format can be included with the request for access to the one or more model files. In other or similar embodiments, the request can include an indication of a type of the client device, a type of one or more hardware components of the client device, an application (or application instance) executing using the client device, and so forth. Processing logic can determine the rendering format that corresponds to the client device based on the indication of the request. For example, processing logic can access a data structure (e.g., a table) that includes entries that map a rendering format to a type of client device, a type of hardware components, a type of an application, etc. The data structure can be stored at memory 250 and/or at memory 450, in some embodiments. Processing logic can identify an entry of the data structure that corresponds to the type of the client device, the type of one or more hardware components of the client device, the application (or application instance) executing using the client device, etc. to determine the rendering format associated with the client device.

At block 724, processing logic identifies a subset of the image rendering data (e.g., a model file, etc.) having a distinct rendering format that corresponds to the determined rendering format associated with the client device. As indicated above, processing logic can generate and/or update model files (e.g., according to block 714) that each have a distinct rendering format. Processing logic can identify the model file of the generated and/or updated model files that has the rendering format corresponding to the rendering format determined for the client device. In some embodiments, processing logic may determine that the model files generated and/or updated for the rendering of the animation of the real-world object do not have a rendering format that corresponds to the determined rendering format for the client device. In such embodiments, processing logic can generate and/or update a model file to have the determined rendering format for the client device, in some instances, can store the generated and/or updated rendering file with model files 258A-N at memory 250 and/or with model files 452A-N at memory 450, as described above.

At block 726, processing logic provides identified subset of the image rendering data (e.g., the identified model file) to the client device for execution to generate the rendering of the real-world object according to the one or more animations. A rendering engine at or otherwise accessible to the client device can execute the model file according to the rendering format associated with the client device, as described herein. Upon execution of the model file, a rendering of the animation of the real-world object can be generated. The client device can provide a user with access to the rendering of the animations via a GUI of the client device, as described herein.

In additional or alternative embodiments, processing logic can receive an additional request from an additional client device for access to the one or more model files associated with the rendering of the real-world object. In response to receiving the additional request, processing logic can determine a rendering format associated with the additional client device. The determined rendering format associated with the additional client device can be distinct from the rendering format determined for the client device (e.g., described with respect to blocks 716-722 of FIG. 7). Processing logic can identify a model file associated with the rendering format determined from the additional client device and can provide the identified model file to the additional client device, as described above. As illustrated herein, embodiments of the present disclosure enable the platform to generate model files that can be executed by rendering engines according to distinct rendering formats (e.g., that are supported by client devices accessing the model files).

As described herein, embodiments of the present disclosure enable a designer and/or developer of a 3D object to create or customize an animation of a real-world object. In some embodiments, the designer and/or the developer may wish to make changes to the rendering of the real-world object (e.g., to include customized features or details). In some embodiments, the designer and/or the developer can update the rendering of the real-world object using 3D object animation tools, such as those provided by GeForce™ by NVIDIA Corporation. The designer and/or the developer can generate or otherwise obtain the 3D object depicting the real-world object using other techniques of image capture for animation (e.g., by NVIDIA Corporation). In other or similar embodiments, platform 120 can provide one or more tools or interfaces that enable the rendering of the real-world object to be updated based on one or more outputs of generative model 620 620, described with respect to FIG. 6. In an illustrative example, a designer and/or a developer (or other such type of user of platform 120) can interact with QT 601 using a UI 642 to provide a user query. The user query can indicate one or more modifications or changes to the rendering of the real-world object. In some embodiments, the user query can be provided in a natural language to the designer and/or the developer. The query can be provided to GM 620, in accordance with above described embodiments. In some embodiments, the one or more model files associated with the rendering of the real-world object can be provided to GM 620. Platform 120 can obtain one or more outputs from GM 620 and can extract, from the one or more outputs, data reflecting the update to the rendering of the real-world object, as requested by the designer and/or developer. The update data extracted from the one or more outputs can include updated data and/or instructions associated with rendering the animation of the real-world object. Platform 120 can update the model file(s) associated with the real-world object based on the extracted data, in some embodiments. In other or similar embodiments, platform 120 can extract, from one or more outputs from GM 620, an updated model file that reflects the updates to the rendering the real-world object.

In an illustrative example, the real-world object can be a jacket that is to be worn by a character in a video game environment. Platform 120 can generate and/or update one or more model files associated with generating a rendering of an animation of the jacket (and/or the character wearing the jacket), as described herein. A designer and/or developer can provide via QT 601 a query to update the rendering of the jacket to include customized piping on the sleeves of the jacket. The query can be provided in a natural language to the designer and/or the developer (e.g., “Update the rendering of the jacket to include piping on the sleeves”). The query can be provided to GM 620 and platform 120 can obtain one or more outputs of GM 620 (e.g., data reflecting the update to the rendering and/or a model file reflecting the update).

### Inference and Training Logic

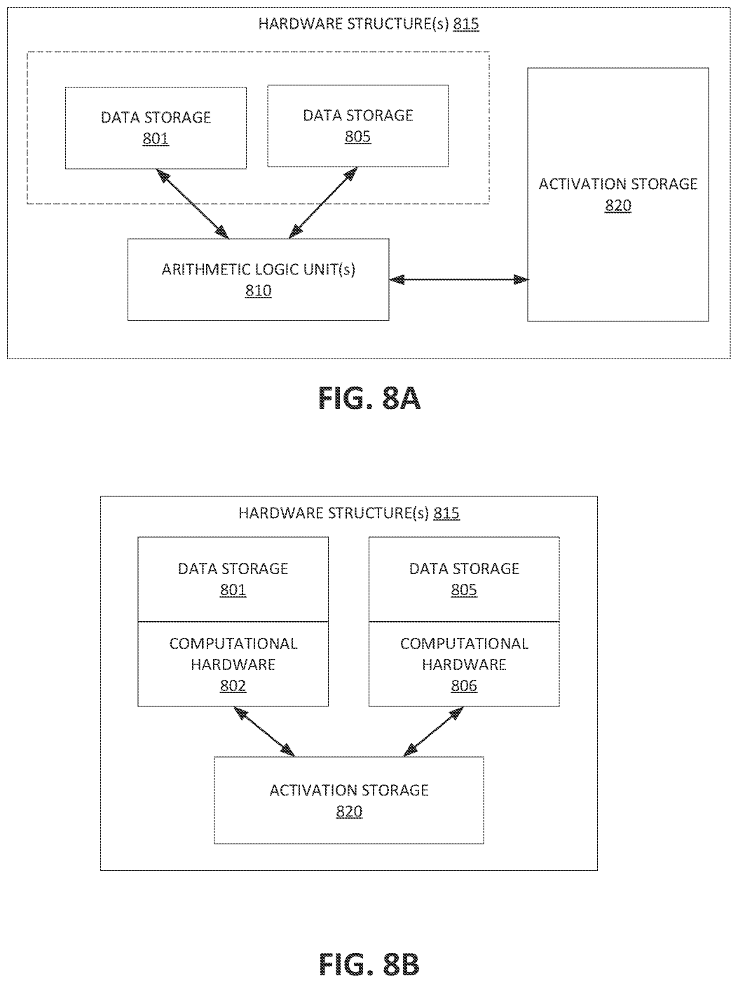

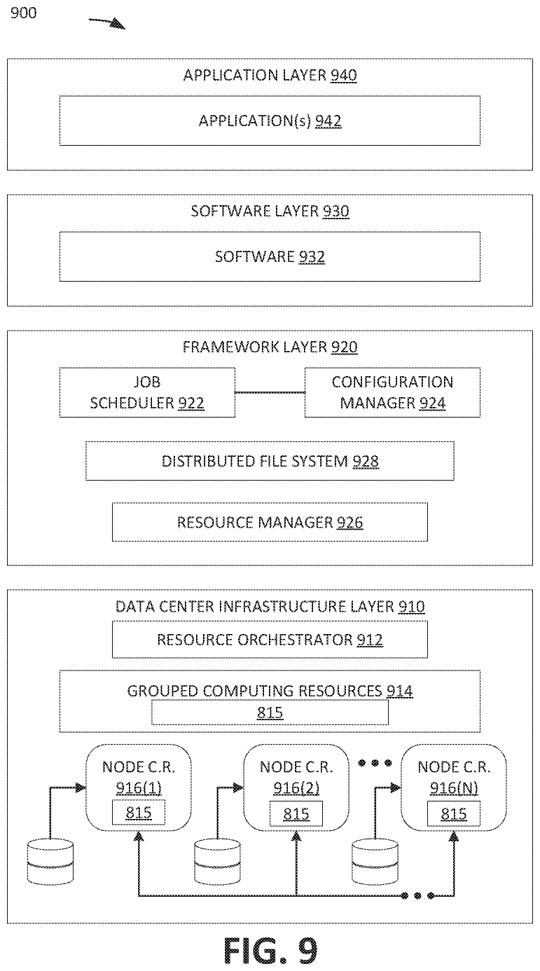

FIG. 8A illustrates hardware structure(s) 815 for inference and/or training logic used to perform inferencing and/or training operations associated with one or more embodiments. Details regarding inference and/or training logic are provided below in conjunction with FIGS. 8A and/or 8B.

In at least one embodiment, hardware structure(s) 815 for inference and/or training logic may include, without limitation, code and/or data storage 801 to store forward and/or output weight and/or input/output data, and/or other parameters to configure neurons or layers of a neural network trained and/or used for inferencing in aspects of one or more embodiments. In at least one embodiment, training logic may include, or be coupled to code and/or data storage 801 to store graph code or other software to control timing and/or order, in which weight and/or other parameter information is to be loaded to configure, logic, including integer and/or floating point units (collectively, arithmetic logic units (ALUs). In at least one embodiment, code, such as graph code, loads weight or other parameter information into processor ALUs based on an architecture of a neural network to which the code corresponds. In at least one embodiment, code and/or data storage 801 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 801 may be included with other on-chip or off-chip data storage, including a processor's L1, L2, or L3 cache or system memory.

In at least one embodiment, any portion of code and/or data storage 801 may be internal or external to one or more processors or other hardware logic devices or circuits. In at least one embodiment, code and/or code and/or data storage 801 may be cache memory, dynamic randomly addressable memory (“DRAM”), static randomly addressable memory (“SRAM”), non-volatile memory (e.g., Flash memory), or other storage. In at least one embodiment, choice of whether code and/or code and/or data storage 801 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, hardware structure(s) 815 for inference and/or training logic may include, without limitation, a code and/or data storage 805 to store backward and/or output weight and/or input/output data corresponding to neurons or layers of a neural network trained and/or used for inferencing in aspects of one or more embodiments. In at least one embodiment, code and/or data storage 805 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic may include, or be coupled to code and/or data storage 805 to store graph code or other software to control timing and/or order, in which weight and/or other parameter information is to be loaded to configure, logic, including integer and/or floating point units (collectively, arithmetic logic units (ALUs)). In at least one embodiment, code, such as graph code, loads weight or other parameter information into processor ALUs based on an architecture of a neural network to which the code corresponds. In at least one embodiment, any portion of code and/or data storage 805 may be included with other on-chip or off-chip data storage, including a processor's L1, L2, or L3 cache or system memory. In at least one embodiment, any portion of code and/or data storage 805 may be internal or external to on one or more processors or other hardware logic devices or circuits. In at least one embodiment, code and/or data storage 805 may be cache memory, DRAM, SRAM, non-volatile memory (e.g., Flash memory), or other storage. In at least one embodiment, choice of whether code and/or data storage 805 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors.

In at least one embodiment, code and/or data storage 801 and code and/or data storage 805 may be separate storage structures. In at least one embodiment, code and/or data storage 801 and code and/or data storage 805 may be same storage structure. In at least one embodiment, code and/or data storage 801 and code and/or data storage 805 may be partially same storage structure and partially separate storage structures. In at least one embodiment, any portion of code and/or data storage 801 and code and/or data storage 805 may be included with other on-chip or off-chip data storage, including a processor's L1, L2, or L3 cache or system memory.

In at least one embodiment, hardware structure(s) 815 for inference and/or training logic may include, without limitation, one or more arithmetic logic unit(s) (“ALU(s)”) 810, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 820 that are functions of input/output and/or weight parameter data stored in code and/or data storage 801 and/or code and/or data storage 805. In at least one embodiment, activations stored in activation storage 820 are generated according to linear algebraic and or matrix-based mathematics performed by ALU(s) 810 in response to performing instructions or other code, wherein weight values stored in code and/or data storage 805 and/or code and/or data storage 801 are used as operands along with other values, such as bias values, gradient information, momentum values, or other parameters or hyperparameters, any or all of which may be stored in code and/or data storage 805 or code and/or data storage 801 or another storage on or off-chip.

In at least one embodiment, ALU(s) 810 are included within one or more processors or other hardware logic devices or circuits, whereas in another embodiment, ALU(s) 810 may be external to a processor or other hardware logic device or circuit that uses them (e.g., a co-processor). In at least one embodiment, ALUs 810 may be included within a processor's execution units or otherwise within a bank of ALUs accessible by a processor's execution units either within same processor or distributed between different processors of different types (e.g., central processing units, graphics processing units, fixed function units, etc.). In at least one embodiment, code and/or data storage 801, code and/or data storage 805, and activation storage 820 may be on same processor or other hardware logic device or circuit, whereas in another embodiment, they may be in different processors or other hardware logic devices or circuits, or some combination of same and different processors or other hardware logic devices or circuits. In at least one embodiment, any portion of activation storage 820 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 820 may be cache memory, DRAM, SRAM, non-volatile memory (e.g., Flash memory), or other storage. In at least one embodiment, activation storage 820 may be completely or partially within or external to one or more processors or other logical circuits. In at least one embodiment, choice of whether activation storage 820 is internal or external to a processor, for example, or comprised of DRAM, SRAM, Flash or some other storage type may depend on available storage on-chip versus off-chip, latency requirements of training and/or inferencing functions being performed, batch size of data used in inferencing and/or training of a neural network, or some combination of these factors. In at least one embodiment, inference and/or training logic described with respect to in FIG. 8A may be used in conjunction with an application-specific integrated circuit (“ASIC”), such as Tensorflow® Processing Unit from Google, an inference processing unit (IPU) from Graphcore™, or a Nervana® (e.g., “Lake Crest”) processor from Intel Corp. In at least one embodiment, inference and/or training logic may be used in conjunction with central processing unit (“CPU”) hardware, graphics processing unit (“GPU”) hardware or other hardware, such as field programmable gate arrays (“FPGAs”).

FIG. 8B illustrates hardware structure(s) 815 for inference and/or training logic, according to at least one or more embodiments. In at least one embodiment, hardware structure(s) 815 may include, without limitation, hardware logic in which computational resources are dedicated or otherwise exclusively used in conjunction with weight values or other information corresponding to one or more layers of neurons within a neural network. In at least one embodiment, inference and/or training logic may be used in conjunction with an application-specific integrated circuit (ASIC), such as Tensorflow® Processing Unit from Google, an inference processing unit (IPU) from Graphcore™, or a Nervana® (e.g., “Lake Crest”) processor from Intel Corp. In at least one embodiment, inference and/or training logic may be used in conjunction with central processing unit (CPU) hardware, graphics processing unit (GPU) hardware or other hardware, such as field programmable gate arrays (FPGAs). In at least one embodiment, hardware structure(s) 815 for inference and/or training logic includes, without limitation, code and/or data storage 801 and code and/or data storage 805, which may be used to store code (e.g., graph code), weight values and/or other information, including bias values, gradient information, momentum values, and/or other parameter or hyperparameter information. In at least one embodiment illustrated in FIG. 8B, each of code and/or data storage 801 and code and/or data storage 805 is associated with a dedicated computational resource, such as computational hardware 802 and computational hardware 806, respectively. In at least one embodiment, each of computational hardware 802 and computational hardware 806 comprises one or more ALUs that perform mathematical functions, such as linear algebraic functions, only on information stored in code and/or data storage 801 and code and/or data storage 805, respectively, result of which is stored in activation storage 820.

In at least one embodiment, each of code and/or data storage 801 and 805 and corresponding computational hardware 802 and 806, respectively, correspond to different layers of a neural network, such that resulting activation from one “storage/computational pair 801/802” of code and/or data storage 801 and computational hardware 802 is provided as an input to “storage/computational pair 805/806” of code and/or data storage 805 and computational hardware 806, in order to mirror conceptual organization of a neural network. In at least one embodiment, each of storage/computational pairs 801/702 and 805/806 may correspond to more than one neural network layer. In at least one embodiment, additional storage/computation pairs (not shown) subsequent to or in parallel with storage computation pairs 801/802 and 805/806 may be included in inference and/or training logic.

### Data Center

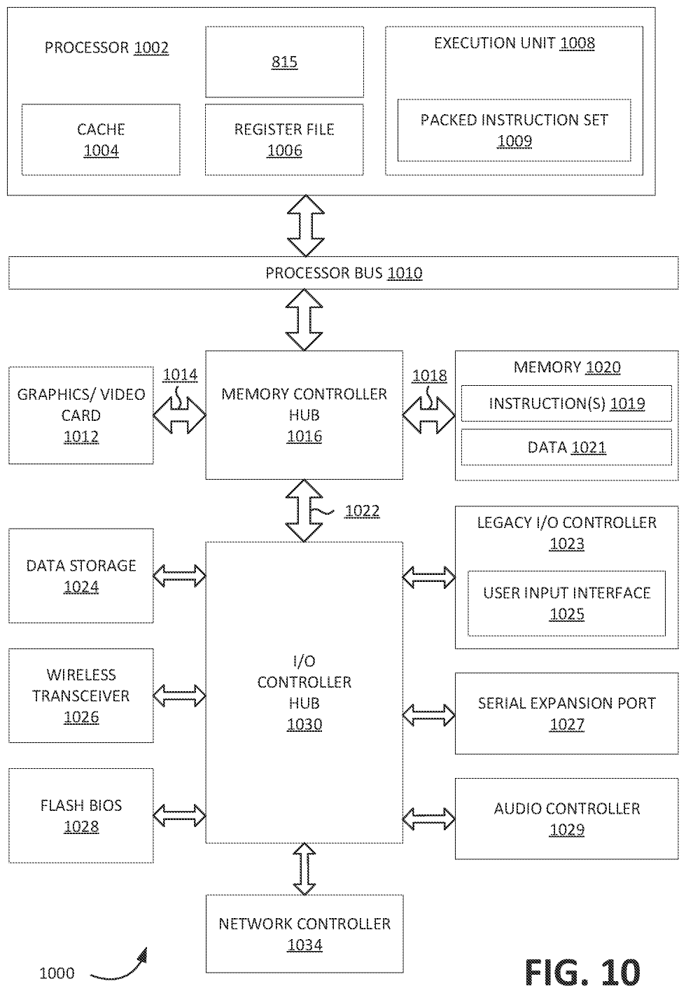

FIG. 9 illustrates an example data center 900, in which at least one embodiment may be used. In at least one embodiment, data center 900 includes a data center infrastructure layer 910, a framework layer 920, a software layer 930, and an application layer 940.

In at least one embodiment, as shown in FIG. 9, data center infrastructure layer 910 may include a resource orchestrator 912, grouped computing resources 914, and node computing resources (“node C.R.s”) 916(1)-1016(N), where “N” represents any whole, positive integer. In at least one embodiment, node C.R.s 916(1)-1016(N) may include, but are not limited to, any number of central processing units (“CPUs”) or other processors (including accelerators, field programmable gate arrays (FPGAs), data processing units, graphics processors, etc.), memory devices (e.g., dynamic read-only memory), storage devices (e.g., solid state or disk drives), network input/output (“NW I/O”) devices, network switches, virtual machines (“VMs”), power modules, and cooling modules, etc. In at least one embodiment, one or more node C.R.s from among node C.R.s 916(1)-1016(N) may be a server having one or more of above-mentioned computing resources.

In at least one embodiment, grouped computing resources 914 may include separate groupings of node C.R.s housed within one or more racks (not shown), or many racks housed in data centers at various geographical locations (also not shown). Separate groupings of node C.R.s within grouped computing resources 914 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 912 may configure or otherwise control one or more node C.R.s 916(1)-1016(N) and/or grouped computing resources 914. In at least one embodiment, resource orchestrator 912 may include a software design infrastructure (“SDI”) management entity for data center 900. In at least one embodiment, resource orchestrator may include hardware, software or some combination thereof.

In at least one embodiment, as shown in FIG. 9, framework layer 920 includes a job scheduler 922, a configuration manager 924, a resource manager 926 and a distributed file system 928. In at least one embodiment, framework layer 920 may include a framework to support software 932 of software layer 930 and/or one or more application(s) 942 of application layer 940. In at least one embodiment, software 932 or application(s) 942 may respectively include web-based service software or applications, such as those provided by Amazon Web Services, Google Cloud and Microsoft Azure. In at least one embodiment, framework layer 920 may be, but is not limited to, a type of free and open-source software web application framework such as Apache Spark™ (hereinafter “Spark”) that may utilize distributed file system 928 for large-scale data processing (e.g., “big data”). In at least one embodiment, job scheduler 922 may include a Spark driver to facilitate scheduling of workloads supported by various layers of data center 900. In at least one embodiment, configuration manager 924 may be capable of configuring different layers such as software layer 930 and framework layer 920 including Spark and distributed file system 928 for supporting large-scale data processing. In at least one embodiment, resource manager 926 may be capable of managing clustered or grouped computing resources mapped to or allocated for support of distributed file system 928 and job scheduler 922. In at least one embodiment, clustered or grouped computing resources may include grouped computing resource 914 at data center infrastructure layer 910. In at least one embodiment, resource manager 926 may coordinate with resource orchestrator 912 to manage these mapped or allocated computing resources.

In at least one embodiment, software 932 included in software layer 930 may include software used by at least portions of node C.R.s 916(1)-1016(N), grouped computing resources 914, and/or distributed file system 928 of framework layer 920. The one or more types of software may include, but are not limited to, Internet web page search software, e-mail virus scan software, database software, and streaming video content software.

In at least one embodiment, application(s) 942 included in application layer 940 may include one or more types of applications used by at least portions of node C.R.s 916(1)-1016(N), grouped computing resources 914, and/or distributed file system 928 of framework layer 920. One or more types of applications may include, but are not limited to, any number of a genomics application, a cognitive compute, and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 924, resource manager 926, and resource orchestrator 912 may implement any number and type of self-modifying actions based on any amount and type of data acquired in any technically feasible fashion. In at least one embodiment, self-modifying actions may relieve a data center operator of data center 900 from making possibly bad configuration decisions and possibly avoiding underutilized and/or poor performing portions of a data center.

In at least one embodiment, data center 900 may include tools, services, software, or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to data center 900. In at least one embodiment, trained machine learning models corresponding to one or more neural networks may be used to infer or predict information using resources described above with respect to data center 900 by using weight parameters calculated through one or more training techniques described herein.

In at least one embodiment, data center may use CPUs, application-specific integrated circuits (ASICs), GPUs, DPUs FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic of hardware structure(s) 815 are used to perform inferencing and/or training operations associated with one or more embodiments. Details regarding inference and/or training logic of hardware structure(s) 815 are provided herein in conjunction with FIGS. 8A and/or 8B. In at least one embodiment, inference and/or training logic of hardware structure(s) 815 may be used in system FIG. 9 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

### Computer Systems

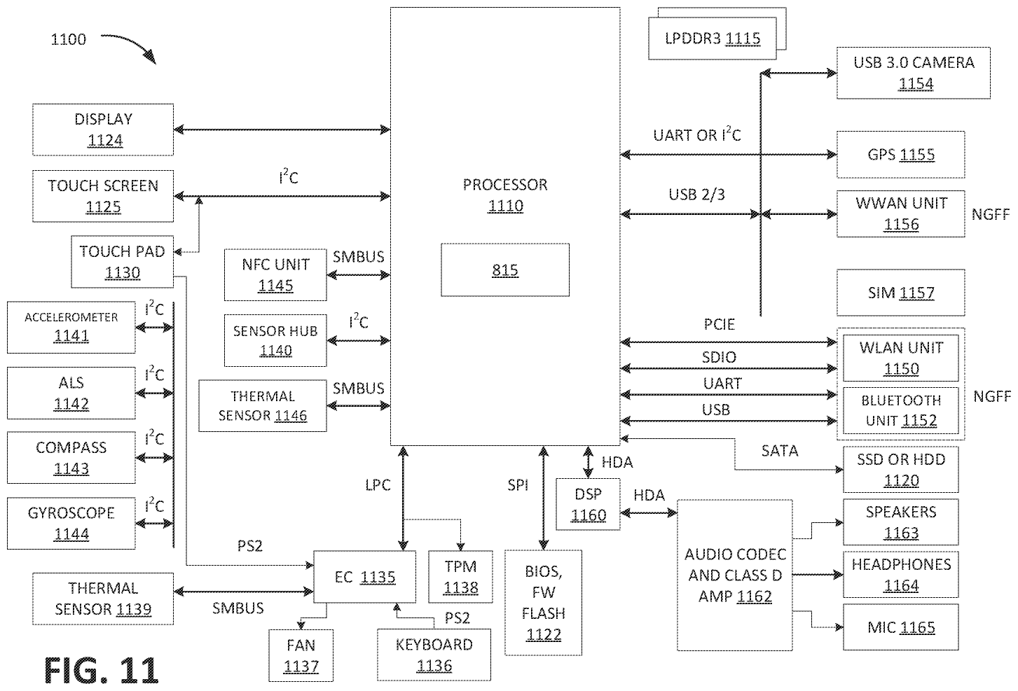

FIG. 10 is a block diagram illustrating an exemplary computer system, which may be a system with interconnected devices and components, a system-on-a-chip (SOC) or some combination thereof 1000 formed with a processor that may include execution units to execute an instruction, according to at least one embodiment. In at least one embodiment, computer system 1000 may include, without limitation, a component, such as a processor 1002 to employ execution units including logic to perform algorithms for process data, in accordance with present disclosure, such as in embodiment described herein. In at least one embodiment, computer system 1000 may include processors, such as PENTIUM® Processor family, Xeon™, Itanium®, XScale™ and/or StrongARM™, Intel® Core™, or Intel® Nervana™ microprocessors available from Intel Corporation of Santa Clara, California, although other systems (including PCs having other microprocessors, engineering workstations, set-top boxes and like) may also be used. In at least one embodiment, computer system 1000 may execute a version of WINDOWS' operating system available from Microsoft Corporation of Redmond, Wash., although other operating systems (UNIX and Linux for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“NetPCs”), set-top boxes, network hubs, wide area network (“WAN”) switches, edge devices, Internet-of-Things (“IoT”) devices, or any other system that may perform one or more instructions in accordance with at least one embodiment.

In at least one embodiment, computer system 1000 may include, without limitation, processor 1002 that may include, without limitation, one or more execution units 1008 to perform machine learning model training and/or inferencing according to techniques described herein. In at least one embodiment, computer system 1000 is a single processor desktop or server system, but in another embodiment computer system 1000 may be a multiprocessor system. In at least one embodiment, processor 1002 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 1002 may be coupled to a processor bus 1010 that may transmit data signals between processor 1002 and other components in computer system 1000.

In at least one embodiment, processor 1002 may include, without limitation, a Level 1 (“L1”) internal cache memory (“cache”) 1004. In at least one embodiment, processor 1002 may have a single internal cache or multiple levels of internal cache. In at least one embodiment, cache memory may reside external to processor 1002. Other embodiments may also include a combination of both internal and external caches depending on particular implementation and needs. In at least one embodiment, register file 1006 may store different types of data in various registers including, without limitation, integer registers, floating point registers, status registers, and instruction pointer register.

In at least one embodiment, execution unit 1008, including, without limitation, logic to perform integer and floating point operations, also resides in processor 1002. In at least one embodiment, processor 1002 may also include a microcode (“ucode”) read only memory (“ROM”) that stores microcode for certain macro instructions. In at least one embodiment, execution unit 1008 may include logic to handle a packed instruction set 1009. In at least one embodiment, by including packed instruction set 1009 in an instruction set of a general-purpose processor 1002, along with associated circuitry to execute instructions, operations used by many multimedia applications may be performed using packed data in a general-purpose processor 1002. In one or more embodiments, many multimedia applications may be accelerated and executed more efficiently by using full width of a processor's data bus for performing operations on packed data, which may eliminate need to transfer smaller units of data across processor's data bus to perform one or more operations one data element at a time.

In at least one embodiment, execution unit 1008 may also be used in microcontrollers, embedded processors, graphics devices, DSPs, and other types of logic circuits. In at least one embodiment, computer system 1000 may include, without limitation, a memory 1020. In at least one embodiment, memory 1020 may be implemented as a Dynamic Random Access Memory (“DRAM”) device, a Static Random Access Memory (“SRAM”) device, flash memory device, or other memory device. In at least one embodiment, memory 1020 may store instruction(s) 1019 and/or data 1021 represented by data signals that may be executed by processor 1002.

In at least one embodiment, system logic chip may be coupled to processor bus 1010 and memory 1020. In at least one embodiment, system logic chip may include, without limitation, a memory controller hub (“MCH”) 1016, and processor 1002 may communicate with MCH 1016 via processor bus 1010. In at least one embodiment, MCH 1016 may provide a high bandwidth memory path 1018 to memory 1020 for instruction and data storage and for storage of graphics commands, data and textures. In at least one embodiment, MCH 1016 may direct data signals between processor 1002, memory 1020, and other components in computer system 1000 and to bridge data signals between processor bus 1010, memory 1020, and a system I/O 1022. In at least one embodiment, system logic chip may provide a graphics port for coupling to a graphics controller. In at least one embodiment, MCH 1016 may be coupled to memory 1020 through a high bandwidth memory path 1018 and graphics/video card 1012 may be coupled to MCH 1016 through an Accelerated Graphics Port (“AGP”) interconnect 1014.

In at least one embodiment, computer system 1000 may use system I/O 1022 that is a proprietary hub interface bus to couple MCH 1016 to I/O controller hub (“ICH”) 1030. In at least one embodiment, ICH 1030 may provide direct connections to some I/O devices via a local I/O bus. In at least one embodiment, local I/O bus may include, without limitation, a high-speed I/O bus for connecting peripherals to memory 1020, chipset, and processor 1002. Examples may include, without limitation, an audio controller 1029, a firmware hub (“flash BIOS”) 1028, a wireless transceiver 1026, a data storage 1024, a legacy I/O controller 1023 containing user input and keyboard interfaces 1025, a serial expansion port 1027, such as Universal Serial Bus (“USB”), and a network controller 1034, which may include in some embodiments, a data processing unit. Data storage 1024 may comprise a hard disk drive, a floppy disk drive, a CD-ROM device, a flash memory device, or other mass storage device.

In at least one embodiment, FIG. 10 illustrates a system, which includes interconnected hardware devices or “chips”, whereas in other embodiments, FIG. 10 may illustrate an exemplary System on a Chip (“SoC”). In at least one embodiment, devices may be interconnected with proprietary interconnects, standardized interconnects (e.g., PCIe) or some combination thereof. In at least one embodiment, one or more components of computer system 1000 are interconnected using compute express link (CXL) interconnects.

Inference and/or training logic of hardware structure(s) 815 are used to perform inferencing and/or training operations associated with one or more embodiments. Details regarding inference and/or training logic of hardware structure(s) 815 are provided herein in conjunction with FIGS. 8A and/or 8B. In at least one embodiment, inference and/or training logic of hardware structure(s) 815 may be used in system FIG. 10 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

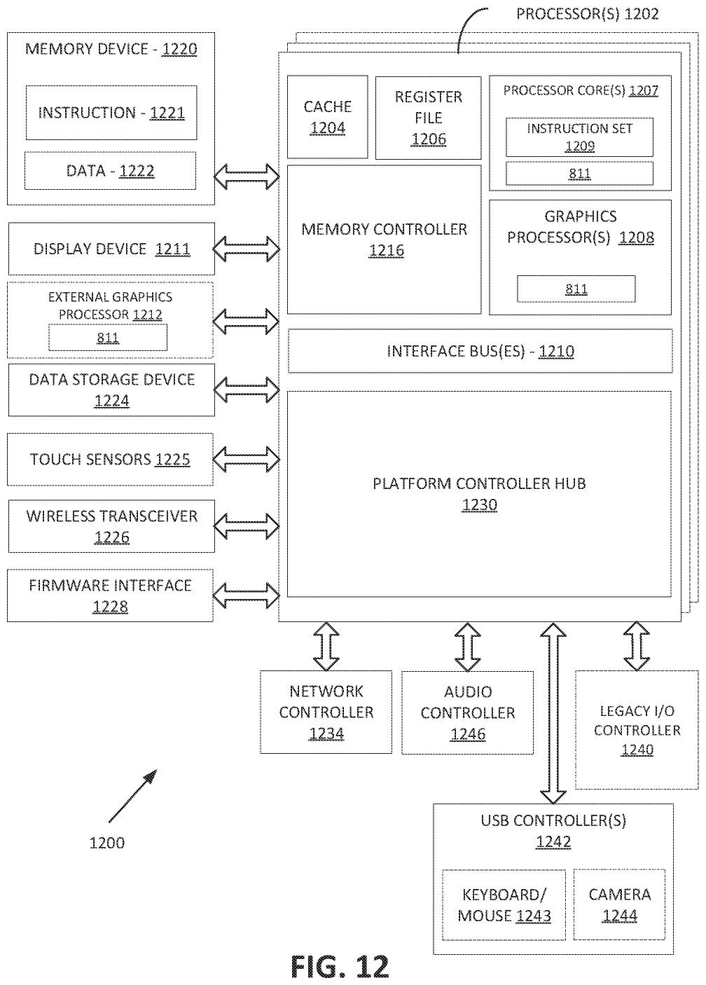

FIG. 11 is a block diagram illustrating an electronic device 1100 for utilizing a processor 1110, according to at least one embodiment. In at least one embodiment, electronic device 1100 may be, for example and without limitation, a notebook, a tower server, a rack server, a blade server, a laptop, a desktop, a tablet, a mobile device, a phone, an embedded computer, an edge device, an IoT device, or any other suitable electronic device.

In at least one embodiment, system 1100 may include, without limitation, processor 1110 communicatively coupled to any suitable number or kind of components, peripherals, modules, or devices. In at least one embodiment, processor 1110 coupled using a bus or interface, such as a 1° C. bus, a System Management Bus (“SMBus”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3), or a Universal Asynchronous Receiver/Transmitter (“UART”) bus. In at least one embodiment, FIG. 11 illustrates a system, which includes interconnected hardware devices or “chips”, whereas in other embodiments, FIG. 11 may illustrate an exemplary System on a Chip (“SoC”). In at least one embodiment, devices illustrated in FIG. 11 may be interconnected with proprietary interconnects, standardized interconnects (e.g., PCIe) or some combination thereof. In at least one embodiment, one or more components of FIG. 11 are interconnected using compute express link (CXL) interconnects.

In at least one embodiment, FIG. 11 may include a display 1124, a touch screen 1125, a touch pad 1130, a Near Field Communications unit (“NFC”) 1145, a sensor hub 1140, a thermal sensor 1146, an Express Chipset (“EC”) 1135, a Trusted Platform Module (“TPM”) 1138, BIOS/firmware/flash memory (“BIOS, FW Flash”) 1122, a DSP 1160, a drive 1120 such as a Solid State Disk (“SSD”) or a Hard Disk Drive (“HDD”), a wireless local area network unit (“WLAN”) 1150, a Bluetooth unit 1152, a Wireless Wide Area Network unit (“WWAN”) 1156, a Global Positioning System (GPS) 1155, a camera (“USB 3.0 camera”) 1154 such as a USB 3.0 camera, and/or a Low Power Double Data Rate (“LPDDR”) memory unit (“LPDDR3”) 1115 implemented in, for example, LPDDR3 standard. These components may each be implemented in any suitable manner.

In at least one embodiment, other components may be communicatively coupled to processor 1110 through components discussed above. In at least one embodiment, an accelerometer 1141, Ambient Light Sensor (“ALS”) 1142, compass 1143, and a gyroscope 1144 may be communicatively coupled to sensor hub 1140. In at least one embodiment, thermal sensor 1139, a fan 1137, a keyboard 1136, and a touch pad 1130 may be communicatively coupled to EC 1135. In at least one embodiment, speaker 1163, headphones 1164, and microphone (“mic”) 1165 may be communicatively coupled to an audio unit (“audio codec and class d amp”) 1162, which may in turn be communicatively coupled to DSP 1160. In at least one embodiment, audio unit 1164 may include, for example and without limitation, an audio coder/decoder (“codec”) and a class D amplifier. In at least one embodiment, SIM card (“SIM”) 1157 may be communicatively coupled to WWAN unit 1156. In at least one embodiment, components such as WLAN unit 1150 and Bluetooth unit 1152, as well as WWAN unit 1156 may be implemented in a Next Generation Form Factor (“NGFF”).

Inference and/or training logic of hardware structure(s) 815 are used to perform inferencing and/or training operations associated with one or more embodiments. Details regarding inference and/or training logic of hardware structure(s) 815 are provided herein in conjunction with FIGS. 8A and/or 8B. In at least one embodiment, inference and/or training logic of hardware structure(s) 815 may be used in system FIG. 11 for inferencing or predicting operations based, at least in part, on weight parameters calculated using neural network training operations, neural network functions and/or architectures, or neural network use cases described herein.

Such components may be used to generate synthetic data imitating failure cases in a network training process, which may help to improve performance of the network while limiting the amount of synthetic data to avoid overfitting.

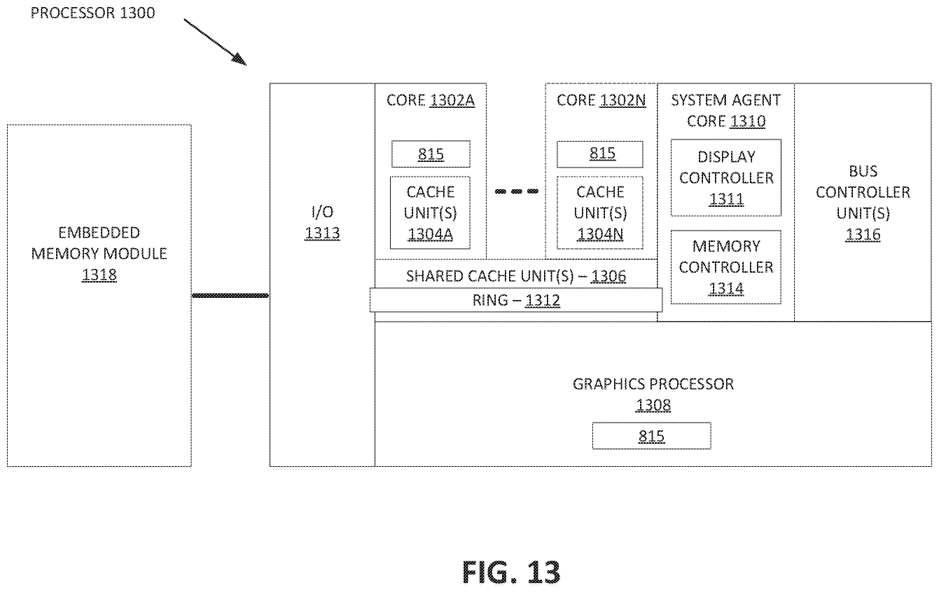

FIG. 12 is a block diagram of a processing system, according to at least one embodiment. In at least one embodiment, system 1200 includes one or more processors 1202 and one or more graphics processors 1208, and may be a single processor desktop system, a multiprocessor workstation system, or a server system having a large number of processors 1202 or processor cores 1207. In at least one embodiment, system 1200 is a processing platform incorporated within a system-on-a-chip (SoC) integrated circuit for use in mobile, handheld, edge, or embedded devices.

In at least one embodiment, system 1200 may include, or be incorporated within a server-based gaming platform, a game console, including a game and media console, a mobile gaming console, a handheld game console, or an online game console. In at least one embodiment, system 1200 is a mobile phone, smart phone, tablet computing device or mobile Internet device. In at least one embodiment, processing system 1200 may also include, couple with, or be integrated within a wearable device, such as a smart watch wearable device, smart eyewear device, augmented reality device, or virtual reality device. In at least one embodiment, processing system 1200 is a television or set top box device having one or more processors 1202 and a graphical interface generated by one or more graphics processors 1208.

In at least one embodiment, one or more processors 1202 each include one or more processor cores 1207 to process instructions which, when executed, perform operations for system and user software. In at least one embodiment, each of one or more processor cores 1207 is configured to process a specific instruction set 1209. In at least one embodiment, instruction set 1209 may facilitate Complex Instruction Set Computing (CISC), Reduced Instruction Set Computing (RISC), or computing via a Very Long Instruction Word (VLIW). In at least one embodiment, processor cores 1207 may each process a different instruction set 1209, which may include instructions to facilitate emulation of other instruction sets. In at least one embodiment, processor core 1207 may also include other processing devices, such a Digital Signal Processor (DSP).

In at least one embodiment, processor 1202 includes cache memory 1204. In at least one embodiment, processor 1202 may have a single internal cache or multiple levels of internal cache. In at least one embodiment, cache memory is shared among various components of processor 1202. In at least one embodiment, processor 1202 also uses an external cache (e.g., a Level-3 (L3) cache or Last Level Cache (LLC)) (not shown), which may be shared among processor cores 1207 using known cache coherency techniques. In at least one embodiment, register file 1206 is additionally included in processor 1202 which may include different types of registers for storing different types of data (e.g., integer registers, floating point registers, status registers, and an instruction pointer register). In at least one embodiment, register file 1206 may include general-purpose registers or other registers.

In at least one embodiment, one or more processor(s) 1202 are coupled with one or more interface bus(es) 1210 to transmit communication signals such as address, data, or control signals between processor 1202 and other components in system 1200. In at least one embodiment, interface bus 1210, in one embodiment, may be a processor bus, such as a version of a Direct Media Interface (DMI) bus. In at least one embodiment, interface 1210 is not limited to a DMI bus, and may include one or more Peripheral Component Interconnect buses (e.g., PCI, PCI Express), memory busses, or other types of interface busses. In at least one embodiment processor(s) 1202 include an integrated memory controller 1216 and a platform controller hub 1230. In at least one embodiment, memory controller 1216 facilitates communication between a memory device and other components of system 1200, while platform controller hub (PCH) 1230 provides connections to I/O devices via a local I/O bus.

In at least one embodiment, memory device 1220 may be a dynamic random access memory (DRAM) device, a static random access memory (SRAM) device, flash memory device, phase-change memory device, or some other memory device having suitable performance to serve as process memory. In at least one embodiment memory device 1220 may operate as system memory for system 1200, to store data 1222 and instructions 1221 for use when one or more processors 1202 executes an application or process. In at least one embodiment, memory controller 1216 also couples with an optional external graphics processor 1212, which may communicate with one or more graphics processors 1208 in processors 1202 to perform graphics and media operations. In at least one embodiment, a display device 1211 may connect to processor(s) 1202. In at least one embodiment display device 1211 may include one or more of an internal display device, as in a mobile electronic device or a laptop device or an external display device attached via a display interface (e.g., DisplayPort, etc.). In at least one embodiment, display device 1211 may include a head mounted display (HMD) such as a stereoscopic display device for use in virtual reality (VR) applications or augmented reality (AR) applications.

In at least one embodiment, platform controller hub 1230 enables peripherals to connect to memory device 1220 and processor 1202 via a high-speed I/O bus. In at least one embodiment, I/O peripherals include, but are not limited to, an audio controller 1246, a network controller 1234, a firmware interface 1228, a wireless transceiver 1226, touch sensors 1225, a data storage device 1224 (e.g., hard disk drive, flash memory, etc.). In at least one embodiment, data storage device 1224 may connect via a storage interface (e.g., SATA) or via a peripheral bus, such as a Peripheral Component Interconnect bus (e.g., PCI, PCI Express). In at least one embodiment, touch sensors 1225 may include touch screen sensors, pressure sensors, or fingerprint sensors. In at least one embodiment, wireless transceiver 1226 may be a Wi-Fi transceiver, a Bluetooth transceiver, or a mobile network transceiver such as a 3G, 4G, or Long Term Evolution (LTE) transceiver. In at least one embodiment, firmware interface 1228 enables communication with system firmware, and may be, for example, a unified extensible firmware interface (UEFI). In at least one embodiment, network controller 1234 may enable a network connection to a wired network. In at least one embodiment, a high-performance network controller (not shown) couples with interface bus 1210. In at least one embodiment, audio controller 1246 is a multi-channel high definition audio controller. In at least one embodiment, system 1200 includes an optional legacy I/O controller 1240 for coupling legacy (e.g., Personal System 2 (PS/2)) devices to system. In at least one embodiment, platform controller hub 1230 may also connect to one or more Universal Serial Bus (USB) controllers 1242 connect input devices, such as keyboard and mouse 1243 combinations, a camera 1244, or other USB input devices.

In at least one embodiment, an instance of memory controller 1216 and platform controller hub 1230 may be integrated into a discreet external graphics processor, such as external graphics processor 1212. In at least one embodiment, platform controller hub 1230 and/or memory controller 1216 may be external to one or more processor(s) 1202. For example, in at least one embodiment, system 1200 may include an external memory controller 1216 and platform controller hub 1230, which may be configured as a memory controller hub and peripheral controller hub within a system chipset that is in communication with processor(s) 1202.

Inference and/or training logic of hardware structure(s) 815 are used to perform inferencing and/or training operations associated with one or more embodiments. Details regarding inference and/or training logic of hardware structure(s) 815 are provided herein in conjunction with FIGS. 8A and/or 8B. In at least one embodiment portions or all of inference and/or training logic of hardware structure(s) 815 may be incorporated into graphics processor 1300. For example, in at least one embodiment, training and/or inferencing techniques described herein may use one or more of ALUs embodied in a graphics processor. Moreover, in at least one embodiment, inferencing and/or training operations described herein may be done using logic other than logic illustrated in FIG. 8A or 8B. In at least one embodiment, weight parameters may be stored in on-chip or off-chip memory and/or registers (shown or not shown) that configure ALUs of a graphics processor to perform one or more machine learning algorithms, neural network architectures, use cases, or training techniques described herein.

Such components may be used to generate synthetic data imitating failure cases in a network training process, which may help to improve performance of the network while limiting the amount of synthetic data to avoid overfitting.

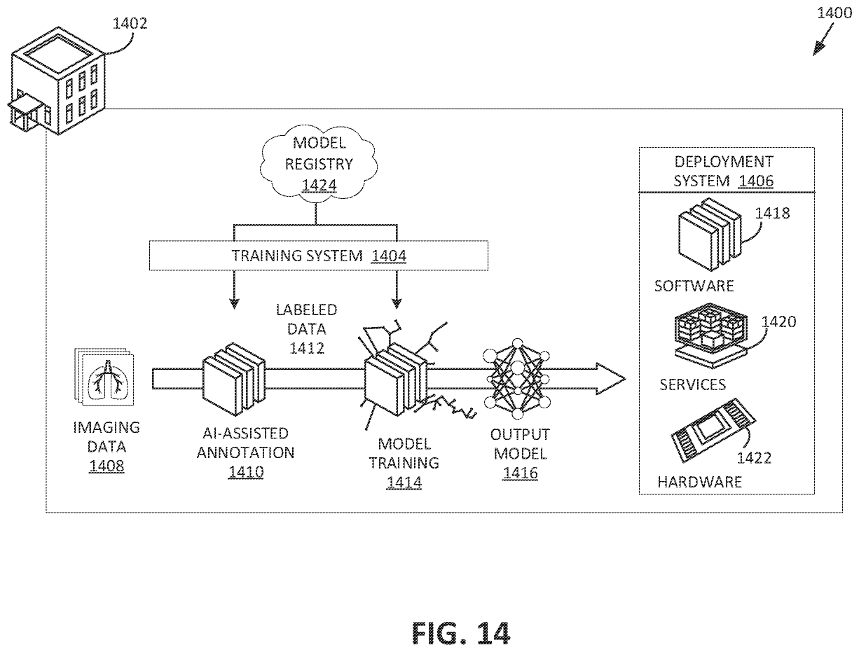

FIG. 13 is a block diagram of a processor 1300 having one or more processor cores 1302A-1402N, an integrated memory controller 1314, and an integrated graphics processor 1308, according to at least one embodiment. In at least one embodiment, processor 1300 may include additional cores up to and including additional core 1302N represented by dashed lined boxes. In at least one embodiment, each of processor cores 1302A-1402N includes one or more internal cache units 1304A-1404N. In at least one embodiment, each processor core also has access to one or more shared cached units 1306.

In at least one embodiment, internal cache units 1304A-1404N and shared cache units 1306 represent a cache memory hierarchy within processor 1300. In at least one embodiment, cache memory units 1304A-1404N may include at least one level of instruction and data cache within each processor core and one or more levels of shared mid-level cache, such as a Level 2 (L2), Level 3 (L3), Level 4 (L4), or other levels of cache, where a highest level of cache before external memory is classified as an LLC. In at least one embodiment, cache coherency logic maintains coherency between various cache units 1306 and 1304A-1404N.

In at least one embodiment, processor 1300 may also include a set of one or more bus controller units 1316 and a system agent core 1310. In at least one embodiment, one or more bus controller units 1316 manage a set of peripheral buses, such as one or more PCI or PCI express busses. In at least one embodiment, system agent core 1310 provides management functionality for various processor components. In at least one embodiment, system agent core 1310 includes one or more integrated memory controllers 1314 to manage access to various external memory devices (not shown).

In at least one embodiment, one or more of processor cores 1302A-1402N include support for simultaneous multi-threading. In at least one embodiment, system agent core 1310 includes components for coordinating and operating cores 1302A-1402N during multi-threaded processing. In at least one embodiment, system agent core 1310 may additionally include a power control unit (PCU), which includes logic and components to regulate one or more power states of processor cores 1302A-1402N and graphics processor 1308.

In at least one embodiment, processor 1300 additionally includes graphics processor 1308 to execute graphics processing operations. In at least one embodiment, graphics processor 1308 couples with shared cache units 1306, and system agent core 1310, including one or more integrated memory controllers 1314. In at least one embodiment, system agent core 1310 also includes a display controller 1311 to drive graphics processor output to one or more coupled displays. In at least one embodiment, display controller 1311 may also be a separate module coupled with graphics processor 1308 via at least one interconnect, or may be integrated within graphics processor 1308.

In at least one embodiment, a ring based interconnect unit 1312 is used to couple internal components of processor 1300. In at least one embodiment, an alternative interconnect unit may be used, such as a point-to-point interconnect, a switched interconnect, or other techniques. In at least one embodiment, graphics processor 1308 couples with ring interconnect 1312 via an I/O link 1313.

In at least one embodiment, I/O link 1313 represents at least one of multiple varieties of I/O interconnects, including an on package I/O interconnect which facilitates communication between various processor components and a high-performance embedded memory module 1318, such as an eDRAM module. In at least one embodiment, each of processor cores 1302A-1402N and graphics processor 1308 use embedded memory modules 1318 as a shared Last Level Cache.

In at least one embodiment, processor cores 1302A-1402N are homogenous cores executing a common instruction set architecture. In at least one embodiment, processor cores 1302A-1402N are heterogeneous in terms of instruction set architecture (ISA), where one or more of processor cores 1302A-1402N execute a common instruction set, while one or more other cores of processor cores 1302A-1402N executes a subset of a common instruction set or a different instruction set. In at least one embodiment, processor cores 1302A-1402N are heterogeneous in terms of microarchitecture, where one or more cores having a relatively higher power consumption couple with one or more power cores having a lower power consumption. In at least one embodiment, processor 1300 may be implemented on one or more chips or as an SoC integrated circuit.

Inference and/or training logic of hardware structure(s) 815 are used to perform inferencing and/or training operations associated with one or more embodiments. Details regarding inference and/or training logic of hardware structure(s) 815 are provided herein in conjunction with FIGS. 8A and/or 8B. In at least one embodiment portions or all of inference and/or training logic of hardware structure(s) 815 may be incorporated into processor 1300. For example, in at least one embodiment, training and/or inferencing techniques described herein may use one or more of ALUs embodied in graphics processor 1308, graphics core(s) 1302A-1402N, or other components in FIG. 13. Moreover, in at least one embodiment, inferencing and/or training operations described herein may be done using logic other than logic illustrated in FIG. 8A or 8B. In at least one embodiment, weight parameters may be stored in on-chip or off-chip memory and/or registers (shown or not shown) that configure ALUs of graphics processor 1300 to perform one or more machine learning algorithms, neural network architectures, use cases, or training techniques described herein.

Such components may be used to generate synthetic data imitating failure cases in a network training process, which may help to improve performance of the network while limiting the amount of synthetic data to avoid overfitting.

### Virtualized Computing Platform

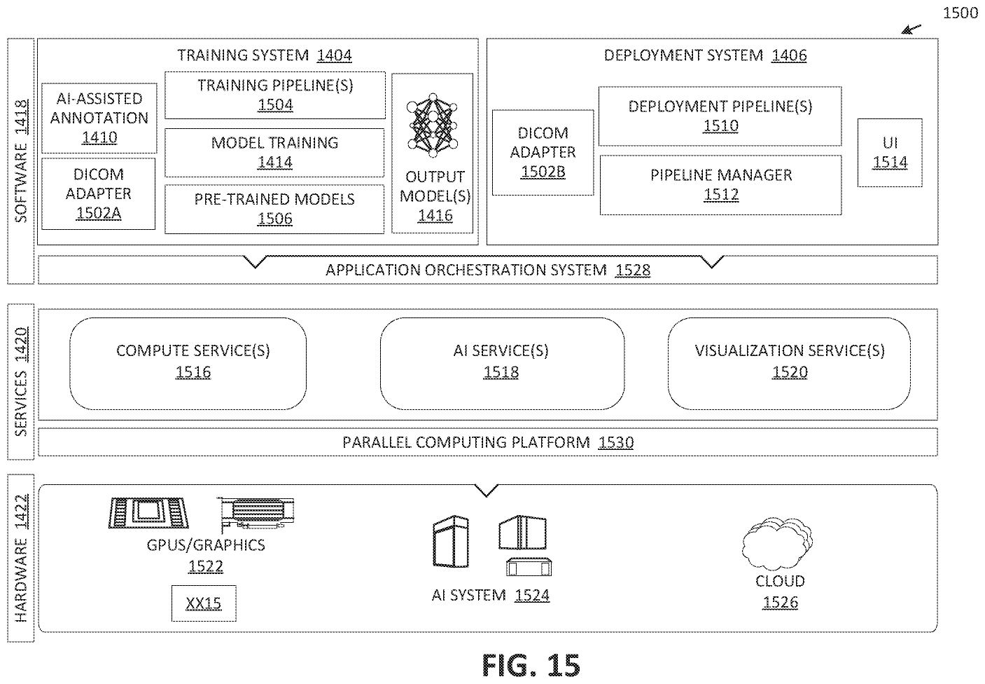

FIG. 14 is an example data flow diagram for a process 1400 of generating and deploying an image processing and inferencing pipeline, in accordance with at least one embodiment. In at least one embodiment, process 1400 may be deployed for use with imaging devices, processing devices, and/or other device types at one or more facilities 1402. Process 1400 may be executed within a training system 1404 and/or a deployment system 1406. In at least one embodiment, training system 1404 may be used to perform training, deployment, and implementation of machine learning models (e.g., neural networks, object detection algorithms, computer vision algorithms, etc.) for use in deployment system 1406. In at least one embodiment, deployment system 1406 may be configured to offload processing and compute resources among a distributed computing environment to reduce infrastructure requirements at facility 1402. In at least one embodiment, one or more applications in a pipeline may use or call upon services (e.g., inference, visualization, compute, AI, etc.) of deployment system 1406 during execution of applications.

In at least one embodiment, some of applications used in advanced processing and inferencing pipelines may use machine learning models or other AI to perform one or more processing steps. In at least one embodiment, machine learning models may be trained at facility 1402 using data 1408 (such as imaging data) generated at facility 1402 (and stored on one or more picture archiving and communication system (PACS) servers at facility 1402), may be trained using imaging or sequencing data 1408 from another facility(ies), or a combination thereof. In at least one embodiment, training system 1404 may be used to provide applications, services, and/or other resources for generating working, deployable machine learning models for deployment system 1406.

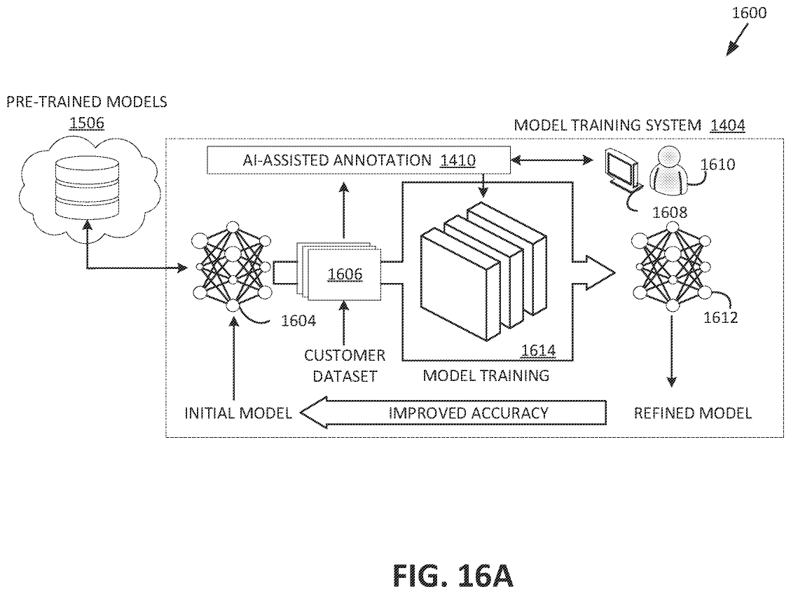

In at least one embodiment, model registry 1424 may be backed by object storage that may support versioning and object metadata. In at least one embodiment, object storage may be accessible through, for example, a cloud storage (e.g., cloud 1526 of FIG. 15) compatible application programming interface (API) from within a cloud platform. In at least one embodiment, machine learning models within model registry 1424 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training pipeline 1504 (FIG. 15) may include a scenario where facility 1402 is training their own machine learning model, or has an existing machine learning model that needs to be optimized or updated. In at least one embodiment, imaging data 1408 generated by imaging device(s), sequencing devices, and/or other device types may be received. In at least one embodiment, once imaging data 1408 is received, AI-assisted annotation 1410 may be used to aid in generating annotations corresponding to imaging data 1408 to be used as ground truth data for a machine learning model. In at least one embodiment, AI-assisted annotation 1410 may include one or more machine learning models (e.g., convolutional neural networks (CNNs)) that may be trained to generate annotations corresponding to certain types of imaging data 1408 (e.g., from certain devices). In at least one embodiment, AI-assisted annotations 1410 may then be used directly, or may be adjusted or fine-tuned using an annotation tool to generate ground truth data. In at least one embodiment, AI-assisted annotations 1410, labeled clinic data 1412, or a combination thereof may be used as ground truth data for training a machine learning model. In at least one embodiment, a trained machine learning model may be referred to as output model 1416, and may be used by deployment system 1406, as described herein.

In at least one embodiment, training pipeline 1504 (FIG. 15) may include a scenario where facility 1402 needs a machine learning model for use in performing one or more processing tasks for one or more applications in deployment system 1406, but facility 1402 may not currently have such a machine learning model (or may not have a model that is optimized, efficient, or effective for such purposes). In at least one embodiment, an existing machine learning model may be selected from a model registry 1424. In at least one embodiment, model registry 1424 may include machine learning models trained to perform a variety of different inference tasks on imaging data. In at least one embodiment, machine learning models in model registry 1424 may have been trained on imaging data from different facilities than facility 1402 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1424. In at least one embodiment, a machine learning model may then be retrained, or updated, at any number of other facilities, and a retrained or updated model may be made available in model registry 1424. In at least one embodiment, a machine learning model may then be selected from model registry 1424—and referred to as output model 1416—and may be used in deployment system 1406 to perform one or more processing tasks for one or more applications of a deployment system.

In at least one embodiment, training pipeline 1504 (FIG. 15), a scenario may include facility 1402 requiring a machine learning model for use in performing one or more processing tasks for one or more applications in deployment system 1406, but facility 1402 may not currently have such a machine learning model (or may not have a model that is optimized, efficient, or effective for such purposes). In at least one embodiment, a machine learning model selected from model registry 1424 may not be fine-tuned or optimized for imaging data 1408 generated at facility 1402 because of differences in populations, robustness of training data used to train a machine learning model, diversity in anomalies of training data, and/or other issues with training data. In at least one embodiment, AI-assisted annotation 1410 may be used to aid in generating annotations corresponding to imaging data 1408 to be used as ground truth data for retraining or updating a machine learning model. In at least one embodiment, labeled data 1412 may be used as ground truth data for training a machine learning model. In at least one embodiment, retraining or updating a machine learning model may be referred to as model training 1414. In at least one embodiment, model training 1414—e.g., AI-assisted annotations 1410, labeled clinic data 1412, or a combination thereof—may be used as ground truth data for retraining or updating a machine learning model. In at least one embodiment, a trained machine learning model may be referred to as output model 1416, and may be used by deployment system 1406, as described herein.

In at least one embodiment, deployment system 1406 may include software 1418, services 1420, hardware 1422, and/or other components, features, and functionality. In at least one embodiment, deployment system 1406 may include a software “stack,” such that software 1418 may be built on top of services 1420 and may use services 1420 to perform some or all of processing tasks, and services 1420 and software 1418 may be built on top of hardware 1422 and use hardware 1422 to execute processing, storage, and/or other compute tasks of deployment system 1406. In at least one embodiment, software 1418 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1408, in addition to containers that receive and configure imaging data for use by each container and/or for use by facility 1402 after processing through a pipeline (e.g., to convert outputs back to a usable data type). In at least one embodiment, a combination of containers within software 1418 (e.g., that make up a pipeline) may be referred to as a virtual instrument (as described in more detail herein), and a virtual instrument may leverage services 1420 and hardware 1422 to execute some or all processing tasks of applications instantiated in containers.

In at least one embodiment, a data processing pipeline may receive input data (e.g., imaging data 1408) in a specific format in response to an inference request (e.g., a request from a user of deployment system 1406). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output models 1416 of training system 1404.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1424 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1420 as a system (e.g., system 1500 of FIG. 15). In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by system 1500 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system (e.g., system 1500 of FIG. 15). In at least one embodiment, completed and validated applications or containers may be stored in a container registry and associated machine learning models may be stored in model registry 1424. In at least one embodiment, a requesting entity—who provides an inference or image processing request—may browse a container registry and/or model registry 1424 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1406 (e.g., a cloud) to perform processing of data processing pipeline. In at least one embodiment, processing by deployment system 1406 may include referencing selected elements (e.g., applications, containers, models, etc.) from a container registry and/or model registry 1424. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1420 may be leveraged. In at least one embodiment, services 1420 may include compute services, artificial intelligence (AI) services, visualization services, and/or other service types. In at least one embodiment, services 1420 may provide functionality that is common to one or more applications in software 1418, so functionality may be abstracted to a service that may be called upon or leveraged by applications. In at least one embodiment, functionality provided by services 1420 may run dynamically and more efficiently, while also scaling well by allowing applications to process data in parallel (e.g., using a parallel computing platform 1530 (FIG. 15)). In at least one embodiment, rather than each application that shares a same functionality offered by a service 1420 being required to have a respective instance of service 1420, service 1420 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where a service 1420 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1418 implementing advanced processing and inferencing pipeline that includes segmentation application and anomaly detection application may be streamlined because each application may call upon a same inference service to perform one or more inferencing tasks.

In at least one embodiment, hardware 1422 may include GPUs, CPUs, DPUs, graphics cards, an AI/deep learning system (e.g., an AI supercomputer, such as NVIDIA's DGX), a cloud platform, or a combination thereof. In at least one embodiment, different types of hardware 1422 may be used to provide efficient, purpose-built support for software 1418 and services 1420 in deployment system 1406. In at least one embodiment, use of GPU processing may be implemented for processing locally (e.g., at facility 1402), within an AI/deep learning system, in a cloud system, and/or in other processing components of deployment system 1406 to improve efficiency, accuracy, and efficacy of image processing and generation. In at least one embodiment, software 1418 and/or services 1420 may be optimized for GPU processing with respect to deep learning, machine learning, and/or high-performance computing, as non-limiting examples. In at least one embodiment, at least some of computing environment of deployment system 1406 and/or training system 1404 may be executed in a datacenter one or more supercomputers or high performance computing systems, with GPU optimized software (e.g., hardware and software combination of NVIDIA's DGX System). In at least one embodiment, hardware 1422 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform may further include DPU processing to transmit data received over a network and/or through a network controller or other network interface directly to (e.g., a memory of) one or more GPU(s). In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 15 is a system diagram for an example system 1500 for generating and deploying an imaging deployment pipeline, in accordance with at least one embodiment. In at least one embodiment, system 1500 may be used to implement process 1400 of FIG. 14 and/or other processes including advanced processing and inferencing pipelines. In at least one embodiment, system 1500 may include training system 1404 and deployment system 1406. In at least one embodiment, training system 1404 and deployment system 1406 may be implemented using software 1418, services 1420, and/or hardware 1422, as described herein.

In at least one embodiment, system 1500 (e.g., training system 1404 and/or deployment system 1406) may implemented in a cloud computing environment (e.g., using cloud 1526). In at least one embodiment, system 1500 may be implemented locally with respect to a healthcare services facility, or as a combination of both cloud and local computing resources. In at least one embodiment, access to APIs in cloud 1526 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1500, may be restricted to a set of public IPs that have been vetted or authorized for interaction.

In at least one embodiment, various components of system 1500 may communicate between and among one another using any of a variety of different network types, including but not limited to local area networks (LANs) and/or wide area networks (WANs) via wired and/or wireless communication protocols. In at least one embodiment, communication between facilities and components of system 1500 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1404 may execute training pipelines 1504, similar to those described herein with respect to FIG. 14. In at least one embodiment, where one or more machine learning models are to be used in deployment pipelines 1510 by deployment system 1406, training pipelines 1504 may be used to train or retrain one or more (e.g., pre-trained) models, and/or implement one or more of pre-trained models 1506 (e.g., without a need for retraining or updating). In at least one embodiment, as a result of training pipelines 1504, output model(s) 1416 may be generated. In at least one embodiment, training pipelines 1504 may include any number of processing steps, such as but not limited to imaging data (or other input data) conversion or adaption In at least one embodiment, for different machine learning models used by deployment system 1406, different training pipelines 1504 may be used. In at least one embodiment, training pipeline 1504 similar to a first example described with respect to FIG. 14 may be used for a first machine learning model, training pipeline 1504 similar to a second example described with respect to FIG. 14 may be used for a second machine learning model, and training pipeline 1504 similar to a third example described with respect to FIG. 14 may be used for a third machine learning model. In at least one embodiment, any combination of tasks within training system 1404 may be used depending on what is required for each respective machine learning model. In at least one embodiment, one or more of machine learning models may already be trained and ready for deployment so machine learning models may not undergo any processing by training system 1404, and may be implemented by deployment system 1406.

In at least one embodiment, output model(s) 1416 and/or pre-trained model(s) 1506 may include any types of machine learning models depending on implementation or embodiment.

In at least one embodiment, and without limitation, machine learning models used by system 1500 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

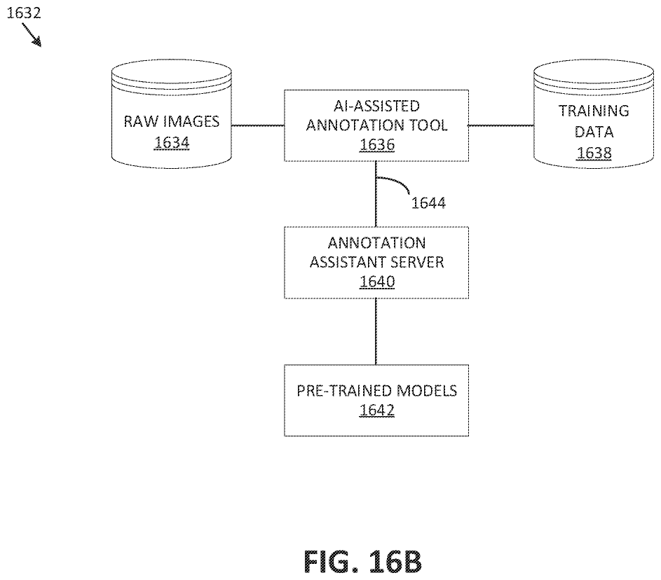

In at least one embodiment, training pipelines 1504 may include AI-assisted annotation, as described in more detail herein with respect to at least FIG. 16B. In at least one embodiment, labeled data 1412 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1408 (or other data type used by machine learning models), there may be corresponding ground truth data generated by training system 1404. In at least one embodiment, AI-assisted annotation may be performed as part of deployment pipelines 1510; either in addition to, or in lieu of AI-assisted annotation included in training pipelines 1504. In at least one embodiment, system 1500 may include a multi-layer platform that may include a software layer (e.g., software 1418) of diagnostic applications (or other application types) that may perform one or more medical imaging and diagnostic functions. In at least one embodiment, system 1500 may be communicatively coupled to (e.g., via encrypted links) PACS server networks of one or more facilities. In at least one embodiment, system 1500 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1402). In at least one embodiment, applications may then call or execute one or more services 1420 for performing compute, AI, or visualization tasks associated with respective applications, and software 1418 and/or services 1420 may leverage hardware 1422 to perform processing tasks in an effective and efficient manner.

In at least one embodiment, deployment system 1406 may execute deployment pipelines 1510. In at least one embodiment, deployment pipelines 1510 may include any number of applications that may be sequentially, non-sequentially, or otherwise applied to imaging data (and/or other data types) generated by imaging devices, sequencing devices, genomics devices, etc.—including AI-assisted annotation, as described above. In at least one embodiment, as described herein, a deployment pipeline 1510 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline 1510 depending on information desired from data generated by a device. In at least one embodiment, where detections of anomalies are desired from an MRI machine, there may be a first deployment pipeline 1510, and where image enhancement is desired from output of an MRI machine, there may be a second deployment pipeline 1510.

In at least one embodiment, an image generation application may include a processing task that includes use of a machine learning model. In at least one embodiment, a user may desire to use their own machine learning model, or to select a machine learning model from model registry 1424. In at least one embodiment, a user may implement their own machine learning model or select a machine learning model for inclusion in an application for performing a processing task. In at least one embodiment, applications may be selectable and customizable, and by defining constructs of applications, deployment, and implementation of applications for a particular user are presented as a more seamless user experience. In at least one embodiment, by leveraging other features of system 1500—such as services 1420 and hardware 1422—deployment pipelines 1510 may be even more user friendly, provide for easier integration, and produce more accurate, efficient, and timely results.

In at least one embodiment, deployment system 1406 may include a user interface 1514 (e.g., a graphical user interface, a web interface, etc.) that may be used to select applications for inclusion in deployment pipeline(s) 1510, arrange applications, modify, or change applications or parameters or constructs thereof, use and interact with deployment pipeline(s) 1510 during set-up and/or deployment, and/or to otherwise interact with deployment system 1406. In at least one embodiment, although not illustrated with respect to training system 1404, user interface 1514 (or a different user interface) may be used for selecting models for use in deployment system 1406, for selecting models for training, or retraining, in training system 1404, and/or for otherwise interacting with training system 1404.

In at least one embodiment, pipeline manager 1512 may be used, in addition to an application orchestration system 1528, to manage interaction between applications or containers of deployment pipeline(s) 1510 and services 1420 and/or hardware 1422. In at least one embodiment, pipeline manager 1512 may be configured to facilitate interactions from application to application, from application to service 1420, and/or from application or service to hardware 1422. In at least one embodiment, although illustrated as included in software 1418, this is not intended to be limiting, and in some examples (e.g., as illustrated in FIG. 13) pipeline manager 1512 may be included in services 1420. In at least one embodiment, application orchestration system 1528 (e.g., Kubernetes, DOCKER, etc.) may include a container orchestration system that may group applications into containers as logical units for coordination, management, scaling, and deployment. In at least one embodiment, by associating applications from deployment pipeline(s) 1510 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1512 and application orchestration system 1528. In at least one embodiment, so long as an expected input and/or output of each container or application is known by a system (e.g., based on constructs of applications or containers), application orchestration system 1528 and/or pipeline manager 1512 may facilitate communication among and between, and sharing of resources among and between, each of applications or containers. In at least one embodiment, because one or more of applications or containers in deployment pipeline(s) 1510 may share same services and resources, application orchestration system 1528 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1528) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1420 leveraged by and shared by applications or containers in deployment system 1406 may include compute services 1516, AI services 1518, visualization services 1520, and/or other service types. In at least one embodiment, applications may call (e.g., execute) one or more of services 1420 to perform processing operations for an application. In at least one embodiment, compute services 1516 may be leveraged by applications to perform super-computing or other high-performance computing (HPC) tasks. In at least one embodiment, compute service(s) 1516 may be leveraged to perform parallel processing (e.g., using a parallel computing platform 1530) for processing data through one or more of applications and/or one or more tasks of a single application, substantially simultaneously. In at least one embodiment, parallel computing platform 1530 (e.g., NVIDIA's CUDA) may enable general purpose computing on GPUs (GPGPU) (e.g., GPUs 1522). In at least one embodiment, a software layer of parallel computing platform 1530 may provide access to virtual instruction sets and parallel computational elements of GPUs, for execution of compute kernels. In at least one embodiment, parallel computing platform 1530 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1530 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI services 1518 may be leveraged to perform inferencing services for executing machine learning model(s) associated with applications (e.g., tasked with performing one or more processing tasks of an application). In at least one embodiment, AI services 1518 may leverage AI system 1524 to execute machine learning model(s) (e.g., neural networks, such as CNNs) for segmentation, reconstruction, object detection, feature detection, classification, and/or other inferencing tasks. In at least one embodiment, applications of deployment pipeline(s) 1510 may use one or more of output models 1416 from training system 1404 and/or other models of applications to perform inference on imaging data. In at least one embodiment, two or more examples of inferencing using application orchestration system 1528 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1528 may distribute resources (e.g., services 1420 and/or hardware 1422) based on priority paths for different inferencing tasks of AI services 1518.

In at least one embodiment, shared storage may be mounted to AI services 1518 within system 1500. In at least one embodiment, shared storage may operate as a cache (or other storage device type) and may be used to process inference requests from applications. In at least one embodiment, when an inference request is submitted, a request may be received by a set of API instances of deployment system 1406, and one or more instances may be selected (e.g., for best fit, for load balancing, etc.) to process a request. In at least one embodiment, to process a request, a request may be entered into a database, a machine learning model may be located from model registry 1424 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1512) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s) and/or DPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT <1 min) priority while others may have lower priority (e.g., TAT <11 min). In at least one embodiment, model execution times may be measured from requesting institution or entity and may include partner network traversal time, as well as execution on an inference service.

In at least one embodiment, transfer of requests between services 1420 and inference applications may be hidden behind a software development kit (SDK), and robust transport may be provided through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1526, and an inference service may perform inferencing on a GPU.

In at least one embodiment, visualization services 1520 may be leveraged to generate visualizations for viewing outputs of applications and/or deployment pipeline(s) 1510. In at least one embodiment, GPUs 1522 may be leveraged by visualization services 1520 to generate visualizations. In at least one embodiment, rendering effects, such as ray-tracing, may be implemented by visualization services 1520 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization services 1520 may include an internal visualizer, cinematics, and/or other rendering or image processing capabilities or functionality (e.g., ray tracing, rasterization, internal optics, etc.).

In at least one embodiment, hardware 1422 may include GPUs 1522, AI system 1524, cloud 1526, and/or any other hardware used for executing training system 1404 and/or deployment system 1406. In at least one embodiment, GPUs 1522 (e.g., NVIDIA's TESLA and/or QUADRO GPUs) may include any number of GPUs that may be used for executing processing tasks of compute services 1516, AI services 1518, visualization services 1520, other services, and/or any of features or functionality of software 1418. For example, with respect to AI services 1518, GPUs 1522 may be used to perform pre-processing on imaging data (or other data types used by machine learning models), post-processing on outputs of machine learning models, and/or to perform inferencing (e.g., to execute machine learning models). In at least one embodiment, cloud 1526, AI system 1524, and/or other components of system 1500 may use GPUs 1522. In at least one embodiment, cloud 1526 may include a GPU-optimized platform for deep learning tasks. In at least one embodiment, AI system 1524 may use GPUs, and cloud 1526—or at least a portion tasked with deep learning or inferencing—may be executed using one or more AI systems 1524. As such, although hardware 1422 is illustrated as discrete components, this is not intended to be limiting, and any components of hardware 1422 may be combined with, or leveraged by, any other components of hardware 1422.

In at least one embodiment, AI system 1524 may include a purpose-built computing system (e.g., a super-computer or an HPC) configured for inferencing, deep learning, machine learning, and/or other artificial intelligence tasks. In at least one embodiment, AI system 1524 (e.g., NVIDIA's DGX) may include GPU-optimized software (e.g., a software stack) that may be executed using a plurality of GPUs 1522, in addition to DPUs, CPUs, RAM, storage, and/or other components, features, or functionality. In at least one embodiment, one or more AI systems 1524 may be implemented in cloud 1526 (e.g., in a data center) for performing some or all of AI-based processing tasks of system 1500.

In at least one embodiment, cloud 1526 may include a GPU-accelerated infrastructure (e.g., NVIDIA's NGC) that may provide a GPU-optimized platform for executing processing tasks of system 1500. In at least one embodiment, cloud 1526 may include an AI system(s) 1524 for performing one or more of AI-based tasks of system 1500 (e.g., as a hardware abstraction and scaling platform). In at least one embodiment, cloud 1526 may integrate with application orchestration system 1528 leveraging multiple GPUs to enable seamless scaling and load balancing between and among applications and services 1420. In at least one embodiment, cloud 1526 may tasked with executing at least some of services 1420 of system 1500, including compute services 1516, AI services 1518, and/or visualization services 1520, as described herein. In at least one embodiment, cloud 1526 may perform small and large batch inference (e.g., executing NVIDIA's TENSOR RT), provide an accelerated parallel computing API and platform 1530 (e.g., NVIDIA's CUDA), execute application orchestration system 1528 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1500.

FIG. 16A illustrates a data flow diagram for a process 1600 to train, retrain, or update a machine learning model, in accordance with at least one embodiment. In at least one embodiment, process 1600 may be executed using, as a non-limiting example, system 1500 of FIG. 15. In at least one embodiment, process 1600 may leverage services 1420 and/or hardware 1422 of system 1500, as described herein. In at least one embodiment, refined models 1612 generated by process 1600 may be executed by deployment system 1406 for one or more containerized applications in deployment pipelines 1510.

In at least one embodiment, model training 1414 may include retraining or updating an initial model 1604 (e.g., a pre-trained model) using new training data (e.g., new input data, such as customer dataset 1606, and/or new ground truth data associated with input data). In at least one embodiment, to retrain, or update, initial model 1604, output or loss layer(s) of initial model 1604 may be reset, or deleted, and/or replaced with an updated or new output or loss layer(s). In at least one embodiment, initial model 1604 may have previously fine-tuned parameters (e.g., weights and/or biases) that remain from prior training, so training or retraining 1414 may not take as long or require as much processing as training a model from scratch. In at least one embodiment, during model training 1414, by having reset or replaced output or loss layer(s) of initial model 1604, parameters may be updated and re-tuned for a new data set based on loss calculations associated with accuracy of output or loss layer(s) at generating predictions on new, customer dataset 1606 (e.g., image data 1408 of FIG. 14).

In at least one embodiment, pre-trained models 1506 may be stored in a data store, or registry (e.g., model registry 1424 of FIG. 14). In at least one embodiment, pre-trained models 1506 may have been trained, at least in part, at one or more facilities other than a facility executing process 1600. In at least one embodiment, to protect privacy and rights of patients, subjects, or clients of different facilities, pre-trained models 1506 may have been trained, on-premise, using customer or patient data generated on-premise. In at least one embodiment, pre-trained models 1506 may be trained using cloud 1526 and/or other hardware 1422, but confidential, privacy protected patient data may not be transferred to, used by, or accessible to any components of cloud 1526 (or other off premise hardware). In at least one embodiment, where a pre-trained model 1506 is trained at using patient data from more than one facility, pre-trained model 1506 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained model 1506 on-premise and/or off premise, such as in a datacenter or other cloud computing infrastructure.

In at least one embodiment, when selecting applications for use in deployment pipelines 1510, a user may also select machine learning models to be used for specific applications. In at least one embodiment, a user may not have a model for use, so a user may select a pre-trained model 1506 to use with an application. In at least one embodiment, pre-trained model 1506 may not be optimized for generating accurate results on customer dataset 1606 of a facility of a user (e.g., based on patient diversity, demographics, types of medical imaging devices used, etc.). In at least one embodiment, prior to deploying pre-trained model 1506 into deployment pipeline 1510 for use with an application(s), pre-trained model 1506 may be updated, retrained, and/or fine-tuned for use at a respective facility.

In at least one embodiment, a user may select pre-trained model 1506 that is to be updated, retrained, and/or fine-tuned, and pre-trained model 1506 may be referred to as initial model 1604 for training system 1404 within process 1600. In at least one embodiment, customer dataset 1606 (e.g., imaging data, genomics data, sequencing data, or other data types generated by devices at a facility) may be used to perform model training 1414 (which may include, without limitation, transfer learning) on initial model 1604 to generate refined model 1612. In at least one embodiment, ground truth data corresponding to customer dataset 1606 may be generated by training system 1404. In at least one embodiment, ground truth data may be generated, at least in part, by clinicians, scientists, doctors, practitioners, at a facility (e.g., as labeled clinic data 1412 of FIG. 14).

In at least one embodiment, AI-assisted annotation 1410 may be used in some examples to generate ground truth data. In at least one embodiment, AI-assisted annotation 1410 (e.g., implemented using an AI-assisted annotation SDK) may leverage machine learning models (e.g., neural networks) to generate suggested or predicted ground truth data for a customer dataset. In at least one embodiment, user 1610 may use annotation tools within a user interface (a graphical user interface (GUI)) on computing device 1608.

In at least one embodiment, user 1610 may interact with a GUI via computing device 1608 to edit or fine-tune (auto)annotations. In at least one embodiment, a polygon editing feature may be used to move vertices of a polygon to more accurate or fine-tuned locations.

In at least one embodiment, once customer dataset 1606 has associated ground truth data, ground truth data (e.g., from AI-assisted annotation, manual labeling, etc.) may be used by during model training 1414 to generate refined model 1612. In at least one embodiment, customer dataset 1606 may be applied to initial model 1604 any number of times, and ground truth data may be used to update parameters of initial model 1604 until an acceptable level of accuracy is attained for refined model 1612. In at least one embodiment, once refined model 1612 is generated, refined model 1612 may be deployed within one or more deployment pipelines 1510 at a facility for performing one or more processing tasks with respect to medical imaging data.

In at least one embodiment, refined model 1612 may be uploaded to pre-trained models 1506 in model registry 1424 to be selected by another facility. In at least one embodiment, his process may be completed at any number of facilities such that refined model 1612 may be further refined on new datasets any number of times to generate a more universal model.

FIG. 16B is an example illustration of a client-server architecture 1632 to enhance annotation tools with pre-trained annotation models, in accordance with at least one embodiment. In at least one embodiment, AI-assisted annotation tools 1636 may be instantiated based on a client-server architecture 1632. In at least one embodiment, annotation tools 1636 in imaging applications may aid radiologists, for example, identify organs and abnormalities. In at least one embodiment, imaging applications may include software tools that help user 1610 to identify, as a non-limiting example, a few extreme points on a particular organ of interest in raw images 1634 (e.g., in a 3D MRI or CT scan) and receive auto-annotated results for all 2D slices of a particular organ. In at least one embodiment, results may be stored in a data store as training data 1638 and used as (for example and without limitation) ground truth data for training. In at least one embodiment, when computing device 1608 sends extreme points for AI-assisted annotation 1410, a deep learning model, for example, may receive this data as input and return inference results of a segmented organ or abnormality. In at least one embodiment, pre-instantiated annotation tools, such as AI-Assisted Annotation Tool 1636B in FIG. 16B, may be enhanced by making API calls (e.g., API Call 1644) to a server, such as an Annotation Assistant Server 1640 that may include a set of pre-trained models 1642 stored in an annotation model registry, for example. In at least one embodiment, an annotation model registry may store pre-trained models 1642 (e.g., machine learning models, such as deep learning models) that are pre-trained to perform AI-assisted annotation on a particular organ or abnormality. These models may be further updated by using training pipelines 1504. In at least one embodiment, pre-installed annotation tools may be improved over time as new labeled clinic data 1412 is added.

Such components may be used to generate synthetic data imitating failure cases in a network training process, which may help to improve performance of the network while limiting the amount of synthetic data to avoid overfitting.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but may be more when so indicated either explicitly or by context. Further, unless stated otherwise or otherwise clear from context, phrase “based on” means “based at least in part on” and not “based solely on.”

Operations of processes described herein may be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. Obtaining, acquiring, receiving, or inputting analog and digital data may be accomplished in a variety of ways such as by receiving data as a parameter of a function call or a call to an application programming interface. In some implementations, process of obtaining, acquiring, receiving, or inputting analog or digital data may be accomplished by transferring data via a serial or parallel interface. In another implementation, process of obtaining, acquiring, receiving, or inputting analog or digital data may be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data may be accomplished by transferring data as an input or output parameter of a function call, a parameter of an application programming interface or interprocess communication mechanism.

Although discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method comprising:
collecting data for a real-world object, wherein the collected data indicates one or more physical characteristics of the real-world object;
creating, with a computing system, a three-dimensional (3D) object based on some portion of the collected data, wherein the 3D object has a format compatible with a 3D graphics platform;
obtaining, with the computing system, physics simulation data associated with the 3D object moving within the 3D graphics platform; and
storing, with the computing system, image rendering data associated with the 3D object moving within the 3D graphics platform, wherein the image rendering data is based at least in part on the obtained physics simulation data.

2. The method of claim 1, wherein creating the 3D object based on some portion of the collected data comprises:
modifying the collected data to have the format associated with the 3D graphics platform.

3. The method of claim 1, wherein the obtained physics simulation data corresponds to one or more physical positions associated with the real-world object based on a simulated physical behavior of the real-world object.

4. The method of claim 3, wherein the simulated physical behavior of the real-world object corresponds to at least one of a motion behavior associated with the real-world object or a draping behavior associated with the real-world object.

5. The method of claim 3, wherein obtaining the physics simulation data associated with the 3D object comprises:
providing the collected data for the real-world object as input to a physics simulation engine, wherein the physics simulation engine is configured to generate the physics simulation data associated with the real-world object based on the simulated physical behavior of the real-world object in view at least one of soft-body dynamics or rigid-body dynamics associated with the real-world object.

6. The method of claim 1, further comprising:
updating the image rendering data associated with the 3D object moving within the 3D graphics platform, wherein the updated rendering data comprises information pertaining to one or more animations for the rendering of the real-world object based on at least in part on the obtained physics data, and wherein the updated image rendering data is stored with the computing system.

7. The method of claim 6, further comprising:
providing at least a subset of the updated image rendering data associated with the 3D object moving within the 3D graphics platform to an additional computing system for generating the rendering of the real-world object according to the one or more animations.

8. The method of claim 1, wherein the one or more physical characteristics of the real-world object correspond to at least one of a size of the real-world object, a shape of the real-world object, a color of the real-world object, a design associated with the real-world object, one or more materials associated with the real-world object, or one or more defects associated with the real-world object.

9. The method of claim 1, wherein the collected data includes image data comprising at least one of a set of two-dimensional (2D) images depicting the real-world object, a video depicting the real-world object, or a set of three-dimensional (3D) images depicting the real-world object.

10. The method of claim 9, further comprising:
providing the image data as input to an artificial intelligence (AI) model that is trained to predict, based on given image data, one or more physical characteristics associated with objects depicted in the given image data;
obtaining one or more outputs of the AI model; and
extracting, from the obtained one or more outputs of the AI model, characteristic data indicating the one or more physical characteristics of the real-world object, wherein the physics simulation data is further obtained based on the extracted characteristic data.

11. The method of claim 1, wherein the image rendering data corresponds to a plurality of distinct rendering formats, and wherein the method further comprises:
receiving a request from a client device for access to the rendering data associated with the rendering of the real-world object; and
determining a rendering format associated with the client device,
wherein the at least the subset of the image rendering is provided to the client device and has a distinct rendering format that corresponds to the determined rendering format associated with the client device.

12. The method of claim 11, further comprising:
responsive to receiving an additional request from an additional client device for access to the image rendering data associated with the rendering of the 3D object, determining an additional image rendering format associated with the additional client device, wherein the additional rendering format is distinct from the rendering format associated with the client device;
identifying an additional subset of the image rendering data, the additional subset corresponding to the determined additional rendering format; and
providing the additional subset of the image rendering data to the additional client device.

13. The method of claim 11, wherein the rendering format associated with the client device corresponds to at least one of one or more hardware components of the client device or an instance of an application executing using the client device.

14. The method of claim 1, wherein the real-world object is a real-world clothing object, and wherein the method further comprises:
identifying additional image rendering data associated with generating a rendering of a virtual avatar associated with a user interested in the real-world clothing object; and
providing the additional image rendering data to a client device associated with the user with the image rendering data for generating the rendering of the real-world clothing object worn by the virtual avatar.

15. The method of claim 14, further comprising:
receiving a request from the client device to update a rendering of the avatar to provide the avatar in at least one of a particular position, a particular state, or a particular environment;
updating the rendering of the real-world clothing object worn by the user to correspond to the at least one of the particular position, the particular state, or the particular environment of the request; and
providing the updated rendering of the real-world clothing object worn by the user, wherein the updated rendering of the real-world clothing object reflects an updated rendering of the avatar, in accordance with the request.

16. The method of claim 14, further comprising:
determining a comfort level associated with at least one portion of the real-world clothing object worn by the user based on the obtained physics simulation data and user data associated with the user interested in the real-world clothing object; and
providing, for presentation on a GUI on the client device of the user, an indication of the determined comfort level associated with the at least one portion of the real-world clothing object.

17. The method of claim 1, wherein the computing system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for three-dimensional (3D) assets;
a system for performing deep learning operations;
a system implemented using an edge device;
a system implemented using a robot;
a system for performing conversational AI operations;
a system for performing operations using a large language model (LLM);
a system for performing synthetic data generation;
a system for generating synthetic data;
a system for presenting at least one of virtual reality content, augmented reality content, or mixed reality content;
a system implemented at least partially in a data center, or
a system implemented at least partially using cloud computing resources.

18. A system comprising:
one or more processing devices to perform operations comprising:
collecting data for a real-world object, wherein the collected data indicates one or more physical characteristics of the real-world object;
creating, with a computing system, a three-dimensional (3D) object based on some portion of the collected data, wherein the 3D object has a format compatible with a 3D graphics platform;
obtaining, with the computing system, physics simulation data associated with the 3D object moving within the 3D graphics platform; and
storing, with the computing system, image rendering data associated with the 3D object moving within the 3D graphics platform, wherein the image rendering data is based at least in part on the obtained physics simulation data.

19. The system of claim 18, wherein creating the 3D object based on some portion of the collected data comprises:
modifying the collected data to have the format associated with the 3D graphics platform.

20. A processor comprising one or more processing units to:
collect data for a real-world object, wherein the collected data indicates one or more physical characteristics of the real-world object;
create, with a computing system, a three-dimensional (3D) object based on some portion of the collected data, wherein the 3D object has a format compatible with a 3D graphics platform;
obtain, with the computing system, physics simulation data associated with the 3D object moving within the 3D graphics platform; and
store, with the computing system, image rendering data associated with the 3D object moving within the 3D graphics platform, wherein the image rendering data is based at least in part on the obtained physics simulation data.
